(19) United States
(12) Patent Application Publication
(10) Pub. No.: US 2025/0292437 A1
(43) Pub. Date: Sep. 18, 2025

(54) CONFERENCING SYSTEM WITH INTELLIGENT CALIBRATION

(71) Applicant: QSC, LLC, Costa Mesa, CA (US)

(72) Inventors: Ryan PRING, Superior, CO (US); Matthew SKOGMO, Placentia, CA (US); David CLEMENTS, Simi Valley, CA (US); Daniel ALLEN, Erie, CO (US); Sayyed Jaffar Ali RAZA, Fort Collins, CO (US); Jacob Edward LEVSEN, Harleysville, PA (US); Pradeep Kumar MANICKAM, Salem (DT) (IN); Damian Andrea FRICK, Costa Mesa, CA (US)

(73) Assignee: QSC, LLC, Costa Mesa, CA (US)

(21) Appl. No.: 19/083,356

(22) Filed: Mar. 18, 2025

Related U.S. Application Data
(60) Provisional application No. 63/566,675, filed on Mar. 18, 2024.

(51) Int. Cl. G06T 7/80; G06V 40/20; H04N 17/00

(52) U.S. Cl. CPC G06T 7/80; G06V 40/20; H04N 17/002; G06T 2207/10016; G06T 2207/30196

(57) ABSTRACT

A conferencing system may connect a processing unit to a camera and a microphone in a meeting room. A calibration module of the processing unit may generate a calibration strategy prior to obtaining video data from the camera, with the processing unit, in accordance with the calibration strategy. The processing unit may then translate the video data into spatial data that is utilized by a mapping module of the processing unit to identify a physical location of the microphone in the meeting room. The calibration module may determine a field of view operating parameter of the camera in response to the spatial data.

### RELATED APPLICATION

This application claims the priority of application No. 63/566,675 filed on Mar. 18, 2024.

### SUMMARY

Various embodiments of the present disclosure are generally directed to an intelligent manner of accurately recording meeting content, such as, but not limited to, a spatially aware system that allows for optimal digital content capture of people and interactions to provide a seamless and accurate virtual meeting environment.

In some embodiments, a conferencing system may have a visual sensor located in a room along with an acoustic sensor. Each sensor may be connected to a processing unit that employs circuitry of a calibration module to translate data accumulated from the visual sensor into spatial data that corresponds with a physical location of the acoustic sensor in the room and a field of view operating parameter for the visual sensor.

A conferencing system, in some embodiments, may provide intelligent calibration by connecting a processing unit to a first camera and a microphone in a meeting room. A calibration module of the processing unit may generate a calibration strategy that is conducted to obtain video data from the camera. The video data may be translated by the processing unit into spatial data that allows a mapping module of the processing unit to identify a physical location of the microphone in the meeting room from the spatial data.

In some embodiments, the calibration module may further determine a field of view operating parameter of the camera in response to the spatial data.

Intelligent calibration embodiments of a conferencing system may connect a processing unit to a first camera and a first microphone with each of the first camera and the first microphone located in a first meeting room.

In some embodiments, the processing unit may be connected to a second camera and a second microphone with each of the second camera and the second microphone located in a second meeting room.

In some embodiments, a calibration module of the processing unit may generate a room calibration strategy for the first meeting room and the second meeting room prior to conducting the room calibration strategy, with the processing unit, to identify visual characteristics and acoustic characteristics of different locations within each meeting room.

In some embodiments, a learning module of the processing unit may identify a first participant in the first meeting room and a second participant in the second meeting room. An identification module of the processing unit may assign a first unique identifier to the first participant and a second unique identifier to the second participant.

In some embodiments, the processing unit may recognize ambiguation in tracking the first participant and then execute the room calibration strategy to alter an operating parameter of the first camera to disambiguate tracking of the first participant. The processing unit may, in some embodiments, obtain video data from the first camera in accordance with the room calibration strategy and translate the video data into spatial data to identify, with a mapping module of the processing unit and from the spatial data, a physical location of the first microphone in the first meeting room and a physical location of the first participant in the first meeting room.

In some embodiments, the calibration module may determine a field of view operating parameter of the first camera in response to the spatial data before adapting, with an adaptation module of the processing unit, at least one operating parameter of the first camera in response to the physical location of the first participant, the adaptation module adapting the at least one operating parameter with respect to the identified physical location of the first participant in the first meeting room.

These and other features which characterize various embodiments of the present disclosure can be understood in view of the following detailed discussion and the accompanying drawings.

### BRIEF DESCRIPTION OF THE DRAWINGS

FIG. 1 illustrates an example conferencing environment in which various embodiments of the present disclosure can be practiced.

FIG. 2 is a block representation of an audio/visual assembly that may be utilized in the conferencing environment of FIG. 1 in accordance with some embodiments.

FIG. 3 displays aspects of an example conferencing system in which various embodiments may be employed.

FIG. 4 conveys portions of a conferencing system configured in accordance with assorted embodiments.

FIG. 5 is a representation of portions of a conferencing system that may be utilized in a conferencing environment in some embodiments.

FIG. 6 conveys a block representation of portions of an example intelligent conferencing system operated in accordance with various embodiments.

FIG. 7 illustrates aspects of an intelligent conferencing system operated in accordance with various embodiments.

FIG. 8 is a flowchart of an example calibration routine that may be carried out by a conferencing system operated in accordance with various embodiments.

FIG. 9 displays a block representation of portions of an example conferencing system that may carry out assorted embodiments.

FIG. 10 is a logical map of operations that may be conducted by a conferencing system in accordance with some embodiments.

FIG. 11 is a logical map of operations that may be executed by a conferencing system in some embodiments.

FIGS. 12A-12D display block representations of a conferencing system employed in accordance with some embodiments.

FIGS. 13A-13C illustrate aspects of a conferencing system arranged in accordance with various embodiments.

FIG. 14 is a representation of portions of a conferencing system utilized in accordance with assorted embodiments.

FIG. 15 conveys a block representation of portions of a conferencing system in accordance with various embodiments.

FIG. 16 shows aspects of a meeting room in which assorted embodiments of an intelligent conferencing system may be practiced.

FIG. 17 represents portions of a conferencing system operated in accordance with some embodiments.

FIG. 18 illustrates aspects of an example intelligent conferencing system configured and operated in accordance with assorted embodiments.

FIG. 19 displays portions of an example conferencing system arranged in accordance with some embodiments.

FIG. 20 depicts aspects of an example intelligent conferencing system configured and operated in accordance with various embodiments.

FIG. 21 displays portions of an example conferencing system conducted in accordance with various embodiments.

FIG. 22 is a flowchart of operations that may be carried out by an example conferencing system in accordance with assorted embodiments.

FIG. 23 is a flowchart of operations which can be executed with an example conferencing system in accordance with some embodiments.

FIG. 24 is a flowchart of operations that may be carried out by an example conferencing system operated in accordance with some embodiments.

FIG. 25 conveys aspects of a conferencing system conducting assorted embodiments.

FIGS. 26A-26E illustrate portions of a conferencing system operated in accordance with some embodiments.

FIG. 27 graphs operational data associated with carrying out various embodiments of an intelligent conferencing system.

FIG. 28 is a block representation of operations that may be conducted by a conferencing system in accordance with some embodiments.

FIG. 29 plots operational data for embodiments of a conferencing system utilizing assorted embodiments of the present disclosure.

FIG. 30 conveys operational data for a conferencing system operated in accordance with various embodiments.

FIG. 31 is a flowchart of operations that may be carried out by an example conferencing system operated in accordance with some embodiments.

FIG. 32 is a flowchart of operations that may be executed by an example conferencing system operated in accordance with assorted embodiments.

FIG. 33 is a flowchart of operations that may be carried out by an example conferencing system operated in accordance with various embodiments.

FIG. 34 is a flowchart of operations that may be executed by an example conferencing system operated in accordance with some embodiments.

### DETAILED DESCRIPTION

Various embodiments of an intelligent conferencing system are generally directed to optimizing the use of audio/visual equipment across different locations to provide accurate, efficient, and seamless collaborations. Through intelligent selection of equipment and operational parameters for the selected equipment, participants of a meeting, conference, or group located at different physical locations may enjoy an experience similar to, or better than, if all participants were in a common physical location.

By utilizing a rules engine to generate and maintain a layout of a composited screen of participants, a single stream of composite video may be efficiency output, such as over a wireless and/or wired network. The ability to find and individually crop participants of a meeting allows the cropped likeness to be sent to a multiplicity of outputs, such as wireless and/or wired network connections.

With the proliferation of computing devices and digital data, people in different locations may select to visually participate in meetings and groups. While audio conferencing remains available to connect physically separate individuals, the addition of video may provide greater information, efficiency, and enjoyment as inaudible cues, such as body language, facial gestures, and eye movement, can be easily understood. For conventional digital meetings with video, a single static microphone and single static camera are utilized to provide tuned playback that may be sufficient for some environments and types of remote meetings.

However, as greater numbers of audio/visual components are employed and/or greater volumes of different people are participating in a meeting, accurate and responsive audio and visual capture becomes difficult. For instance, a meeting participant that moves around while talking or multiple separate people talking at the same time can pose challenges for which microphone and camera to activate as well as what digital recording parameters are to be employed. Additional challenges may be posed by diverse talking environments that may have different resonances, echoes, and tonal qualities that correspond with different, ideal audio/visual parameters, particularly for audio/visual equipment with different recording characteristics, such as gain, beam width, resolution, and digital signal processing parameters.

Accordingly, embodiments of an intelligent conferencing system may optimize the digital capture of communications between people in separate locations by understanding the environments and people participating in the communications. By identifying aspects of the environment in which people will speak, as well as identifying separate individuals that may become speakers, allows an intelligent conferencing system to proactively, or actively in real-time, adapt audio/visual equipment operating parameters. As a practical result, multiple microphones, cameras, and digital operating parameters may be intelligently utilized to allow optimized control of audio and visual equipment that produces seamless and accurate communications between the separate participants of a virtual meeting or complex single physical meeting space.

Various embodiments are directed to using intelligent video analytics with multiple cameras to automatically produce a video conferencing experience that improves hybrid equity in complex collaborations in high impact spaces. These spaces often include larger numbers of meeting room participants, requiring multiple cameras to capture the best shot for each meeting participant and requiring multiple microphones.

A high-impact space may include a boardroom, a training room, an all-hands room, an auditorium, as well as a divisible space. To automatically produce a custom and optimized video conferencing experience, some embodiments of the conferencing system may use a collection of rules and priorities, some of which will be adjustable, fed by analytics from an artificial intelligence pipeline, sensor fusion, and/or an automatic room calibration scheme to optimize the experience for each environment where the invention is deployed.

In accordance with various embodiments, an intelligent conferencing system may provide room calibration, which can calculate the spatial location of objects within a room based on, for example, one or more of the known physical dimensions of at least one object, the intrinsic distortion of a camera and lens, and the pan, tilt, and zoom (PTZ) settings of a camera that is observing the at least one object. In some embodiments, room calibration may employ the computed physical location of audio/video components in a meeting room to set, alter, and adapt operational parameters of those components to provide efficient, accurate, and complete representation of meeting conditions over time.

Some embodiments of an intelligent conferencing system may provide a video-analytics pipeline that identifies participants, such as live people versus paintings and photos, as well as active talkers, head poses, face identification, and person identification. Three dimensional mapping may be conducted, in some embodiments of an intelligent conferencing system, by using multiple cameras to triangulate the three dimensional location of participants in a meeting.

In some embodiments, an intelligent conferencing system may assign a global unique participant identifier that employs a combination of intelligence techniques, such as cosine distance between facial descriptors or embeddings, and the calculated three dimensional location of participants in a room to generate and assign a unique identifier to each meeting participant. Such a global participant identifier then allows for the unique identification of the same person who may be visible in two or more camera fields of view. Some embodiments of an intelligent conferencing system may provide user placement logic where a three dimensionally mapped location of a person in a room is converted to a two dimensional location within a composited grouping of individuals in the room.

With the knowledge of the spatial information for visual sensors, such as cameras and optical detectors, and acoustic sensors, such as microphones and accelerometers, in some embodiments, a conferencing system may determine the visual and acoustic characteristics of different locations in a meeting room. For instance, a conferencing system may determine where a camera and/or microphone resides in a meeting room and subsequently optimize operating parameters, such as focus, resolution, field of view, gain, and digital signal processing, to accommodate the visual/audio characteristics present at different locations in a meeting room. As a more specific, but not limiting, example, computing the location of a microphone in a meeting room allows a conferencing system to alter the beam forming, gain, and digital filter of the microphone when a meeting participant is in a predetermined location in the meeting room, such as in a chair, in front of a presentation board, or entering through a doorway.

However, the knowledge of the physical location and orientation of audio/visual equipment in a meeting room may not be readily available to a conferencing system. In the event a conferencing system operates without component spatial information, ambiguation may be encountered, such as blurry video, out-of-frame video, noisy audio, or inaudible sounds, which degrades the quality, accuracy, and efficiency of a meeting. It is contemplated that the physical coordinates of meeting equipment may be manually inputted into a conferencing system to allow for relational adaptations of operating, but such manual input may be inefficient during system installation and prone to inaccuracy.

Accordingly, embodiments of a conferencing system may provide intelligent calibration that involves autonomous determination of the physical location of audio/visual meeting equipment as well as the operating capabilities of that equipment, both individually and collectively, to allow for seamless adaptation of equipment operating parameters in response to meeting activity in different locations within a meeting room. The understanding of where audio/visual equipment is in a meeting room, which may be characterized as spatial information, may leverage room calibration for a conferencing system into adaptive operating parameters that maintains optimized collection of meeting conditions, such as sounds, gestures, words, and participant movement.

A conferencing system, in some embodiments, autonomously conducts tests to determine the real-time capabilities of audio/visual equipment. The understanding of the operating capabilities of equipment, in combination with knowledge of the physical location of the respective visual sensors and acoustic sensors, may allow for mitigation, or prevention, of ambiguation in meeting room data. For instance, focal capabilities of a camera and sensing depth for a microphone may allow a conferencing system to calibrate the respective components, and the system as a whole, to reduce ambiguation for selected locations in a meeting room, such as a presentation area or head of a table. Such proactive mitigation of ambiguation may be characterized as disambiguation and may be carried out by a conferencing system at any time before, during, and after a meeting is conducted.

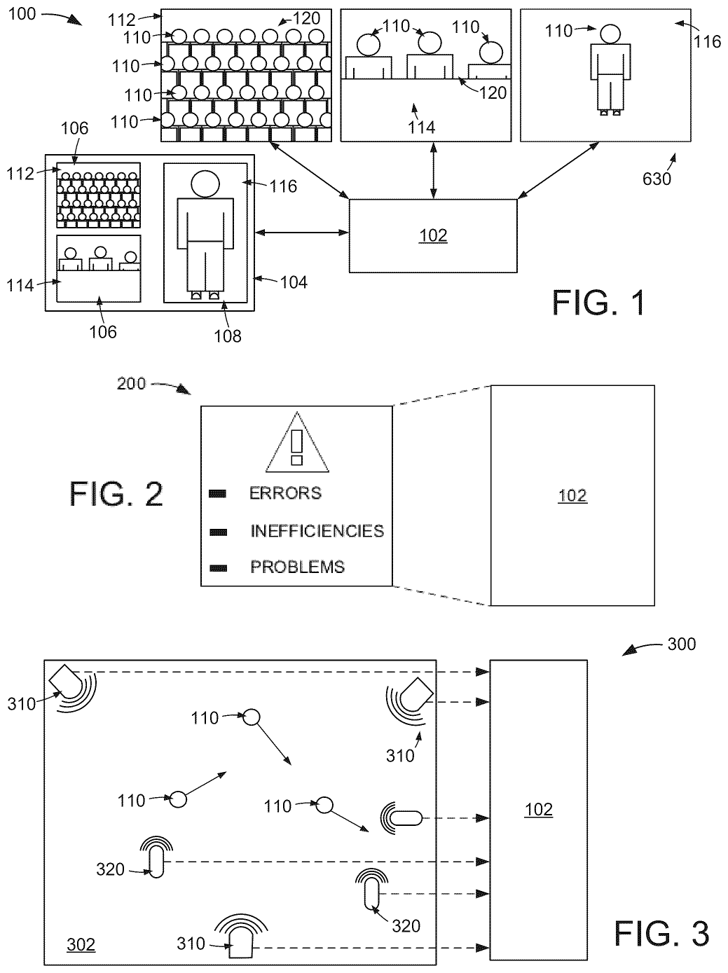

Turning to the drawings, FIG. 1 illustrates aspects of an example conferencing environment 100 in which assorted embodiments are to be practiced. One or more computing devices 102, such as a desktop computer, laptop computer, tablet computer, or other programmable circuitry, may collect, organize, process, and distribute digital information to administer a virtual meeting with participants located at different physical locations. A computing device 102 may employ one or more processors, such as a microprocessor, controller, or other programmable circuitry, along with a memory, such as a volatile random access memory or non-volatile solid-state array, to generate a visual collection of digital data from assorted locations, as illustrated by virtual environment 104. An example computing device 102 may be an AVC core processor, such as the processor described in application Ser. Nos. 17/893,107 and 15/975,144, which are hereby incorporated by reference.

The generated virtual environment 104 may have any organization, theme, look, or arrangement, but some embodiments position different passive participants of a meeting in separate windows 106 while an active participant is presented in a larger window 108. It is contemplated that the computing device 102 alters the size of the various windows 106/108 as different participants become active or inactive through talking and/or activity. As such, the computing device 102 may change assorted aspects of the virtual environment 104 over time in response to detected conditions, such as who is talking, what is being discussed, or who is presenting information.

While a select number of different participant environments are displayed in FIG. 1, the computing device 102 may input any number, and type, of input feeds, as illustrated by solid arrows, and translate those feeds into the collective virtual environment 104. The non-limiting example meeting conveyed in FIG. 1 has a variety of different participants 110 physically located in different locations. It is noted that the virtual environment 104 may represent different participants physically located in a common location, such as an office building, auditorium, or boardroom. However, other embodiments utilize the computing device 102 to virtually bring together participants physically located in different cities, buildings, states, or countries.

One such physical location 112 may have high volume seating, such as a theater, classroom, or lecture hall, where participants 110 are relatively close and the group of participants 120 has a relatively high density. Another physical location 114 providing meeting participants 110 may have less density, as shown, such as a conference room, boardroom, or office. A single participant 110 may also be included in the meeting from a different location 116 without others being physically adjacent. It is noted that the assorted physical locations 112/114/116 may be equipped with any number, and type, of meeting equipment, such as microphones, cameras, and displays. Similarly, the virtual environment 104 can be displayed to any number of users in any type of format, such as a speaker, monitor, television, projection, augmented reality, or virtual reality alone or in combination.

Through the combination of the audio and/or visual digital content transmitted to the computing device 102 via wired and/or wireless signal pathways, the respective participants 110 can conduct simple or complex meetings. Yet, the use of multiple separate audio/visual equipment in different locations 112/114/116 may pose operational difficulties. FIG. 2 illustrates a block representation of portions of an example conferencing system 200 that may be incorporated into the environment 100 of FIG. 1. The computing device 102 of the conferencing system 200 may encounter any number of errors, inefficiencies, and problems.

Although not required or limiting, the conferencing system 200 may detect one or more operating conditions are present, or not present, which correspond with a current, or imminent error. For example, the operating status of a camera may indicate that one or more aspects of the camera is not recording, transmitting, or storing digital information. As another example, monitoring output of a microphone may indicate that a frequency is not being recorded at all, not properly translated from analog to digital content, or not being sent to the computing device 102. It is contemplated that the conferencing system 200 employs one or more external sensors, such as an acoustic detector, signal filter, or electrical detector, to identify the current, real-time status of the assorted cameras, microphones, and conferencing system 200 as a whole, which can be employed to detect the presence of equipment errors.

While the computing device 102 of the conferencing system 200 may detect operating errors, such as inoperable equipment and dropped connections, the status of audio/visual equipment may allow the computing device 102 to identify inefficiencies in translating real-world meeting aspects into digital content transmitted and processed into a virtual environment 104 that accurately represents at least the speech and actions of the assorted meeting participants 110. By evaluating the digital content recorded by audio/visual equipment compared to the real-world aspects of a meeting, the computing device 102 may identify that optimal conferencing conditions are not present. For instance, inefficiencies may involve a low transmission speed, reduced security protection, lagging of digital content, or increased content latency.

The presence of conferencing inefficiencies may allow for the additional evaluation and identification of digital content problems, which may be characterized as aspects of the virtual environment 104 that incorrectly, or poorly, represent the real-world aspects of a meeting. To clarify, an error may correspond with incorrect equipment operation, an inefficiency may correspond with sub-optimal translation of real-world content into a virtual environment, and problems may correspond with aspects of a virtual environment that do not properly represent real-world meeting content. The identification of such errors, inefficiencies, and problems allows the computing device 102 to alert users and/or execute corrective activities to mitigate, or eliminate, the identified issues. For instance, the computing device 102 may detect a virtual environment problem, such as a blurry playback, excessive noise, reduced resolution, incorrect participant position in frame, low light, or incoherent sound, which triggers the activation of at least one corrective action, such as changing active equipment and/or equipment operating parameters, to more produce a virtual environment 104 that more accurately represents the real-world meeting environment.

In general, meeting rooms are setup manually and can be prone to errors during initial installation and subsequent use. Installation equipment, such as tuning equipment, may be used and must be installed and used correctly to accurately capture the audio/visual aspects of a meeting. For instance, the installation and use of specific tuning equipment may be time intensive as equipment is adjusted to get readings for different aspects of a meeting room. In the event audio/visual equipment is installed and tuned properly, meeting participants, and meeting room furniture, may be dynamic over time, which changes the optimal settings to accurately capture the audio and/or video corresponding with the meeting.

Accordingly, various embodiments locate the equipment in a meeting room and use AI to minimize, or eliminate, the need for setup equipment to tune audio/visual components for a meeting room. The ability to optimize the settings for audio and visual recording of dynamic activity and participant behaviors may result from actually moving, panning, or tilting the recording equipment or applying digital processing to efficiently record a meeting or conference involving one or more participants. By testing a meeting room with automated aspects of an intelligent conferencing system, the audio/visual recording equipment may be spatially aware, which allows for accurate triangulation of the location of participants within a room and adjustment of operational recording parameters and settings to accommodate known attributes of the meeting room.

FIG. 3 illustrates aspects of a conferencing system 300 operated in accordance with various embodiments in a conferencing environment. As shown, a single physical meeting environment 302 is configured with an audio/visual arrangement where multiple cameras 310 operate in conjunction with multiple microphones 320 to record digital information pertaining to at least one participant's 110 involvement with a meeting. It is noted that the involvement being captured by one or more camera 310 and/or microphone 320 may comprise audible sound, movement, facial expressions, body language, and any combination thereof over time.

In some embodiments, the various digital capture equipment, which may include the cameras 310, microphones 320, and any other digital storage or processing devices present on-site or in-line with the downstream computing device 102, are initially setup with a default configuration tuned in accordance with an installer's selections. For instance, upon installation of the equipment intended to capture digital content in the meeting environment 302, a default set of parameters, such as physical orientation, electronic gain, and amount of signal processing, is assigned to the respective equipment (cameras 310 & microphones 320) and rarely modified during the operable lifespan of the respective equipment. It is contemplated that installation, or updating, a digital capture component may involve changing one or more default parameters, but is not adapted in real-time while the conferencing system 300 remains fully operational.

Despite initially being tuned with default operational parameters for the respective audio/visual recording and processing equipment, the errors, inefficiencies, and problems discussed in conjunction with FIG. 2 may occur. The presence of large numbers of potential and active meeting participants 110 may be exacerbated by the speed at which different participants 110 speak, or move, that creates difficulties for other participants 110 to follow along, understand, or effectively communicate via a virtual meeting environment 104. As such, the use of multiple cameras 310 along with multiple microphones 320 using tuned parameters may not translate into optimal capture of digital meeting content or a coherent virtual meeting environment 104.

Through the use of a system computing device 102, the conferencing system 300 may identify errors, inefficiencies, and problems that correspond with one or more corrective actions, such as changing equipment, changing equipment operating parameters, or altering digital signal processing. However, such actions directed to correcting errors, inefficiencies, and problems are reactive in nature and may result in a degraded virtual meeting and online conferencing experience for participants 110. Accordingly, various embodiments of the conferencing system 300 and computing device 102 are directed to proactive activities that promote a greater chance for accurate and seamless representation of real-world meeting aspects in the virtual meeting environment 104.

While not required or limiting, the example meeting environment shown in FIG. 3 utilizes multiple cameras 310 and microphones 320 to capture the speech and actions of different participants 110 located in a single room. The use of static operating parameters for the assorted equipment may produce problems, as described above, as the different participants 110 speak concurrently, move about the room, or additional participants 110 become active. For instance, the operating parameters for the audio/visual equipment may be tuned and calibrated only for a narrow range of physical locations within the room. Additionally, the static operating conditions may not be optimal for participants 110 that exhibit different voices, accents, tones, and loudness. Such sub-optimal operating conditions may be exacerbated by concurrent participants 110 speaking, moving, or presenting information.

These issues are addressed by a conferencing system 300 configured in accordance with various embodiments to, for example, calibrate audio/visual equipment for different locations in a meeting room, identify participants 110, locate participants 110 within a meeting room, and/or intelligently adapt equipment operating parameters in real-time and in response to different participants 110 becoming active, or inactive. As such, separate equipment may be optimized over time and in addition to initial operating setup with information pertaining to diverse sound and/or visual characteristics of different participants 110 and locations within meeting rooms.

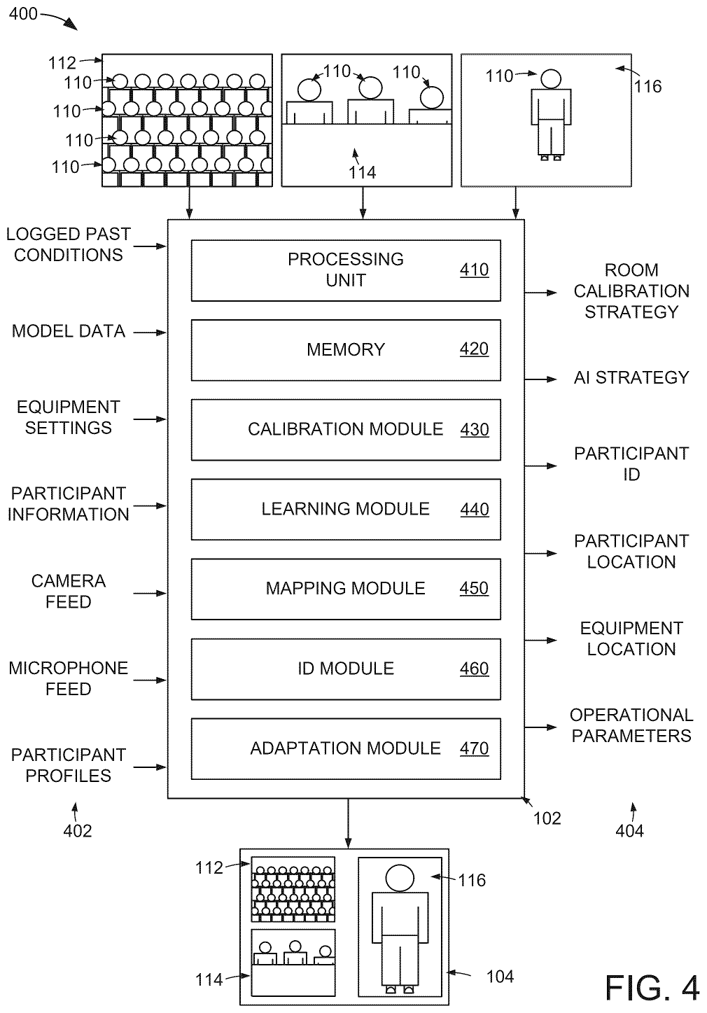

FIG. 4 illustrates a block representation of portions of an example conferencing system 400 that may be employed to provide virtual environments 104 that accurately and seamlessly represent real-world meeting conditions and activity. It is initially noted that while the conferencing system 400 is shown with a single computing device 102 providing hardware to conduct various operations, such arrangement is not required or limiting and any number, and type, of data processing hardware may be employed as part of the conferencing system 400 regardless of the physical location of the data processing hardware. For instance, a supplemental processing, memory, or application specific circuitry may be physically positioned at a different location relative to the computing device 102, but may provide continuous, or selective, support to record an actual real world meeting and translated that meeting into an accurate and seamless virtual environment 104.

The computing device 102 may be structurally configured with a processing unit 410 that provides control and data processing hardware. As an example, the processing unit 410 may comprise a microcontroller, system-on-chip, application specific integrated circuit, or other programmable circuitry, that may operate alone, or with other circuitry of the computing device 102 to translate at least audio and video recordings into a single virtual environment 104. The processing unit 410 may utilize one or more memories 420 to temporarily, or permanently, store information, settings, and data that contribute to the recording of a meeting, translation of the meeting into a virtual environment 104, and optimization of the meeting recordings over time, as facilitated by the processing unit 410.

Although the computing device 102 may have any number of connections and input any volume, and type, or information and data 402, various embodiments utilize camera streams, microphone streams, and sensor information to output information 404 that may be employed to provide at least a virtual environment. Some embodiments of the computing device 102 generates a room calibration and audio/visual strategy while other embodiments employ aspects of the computing device 102 to assign identification tags to meeting participants along with real-time locations of the participants with the respective meeting rooms, which may be used to assign optimal camera and/or microphone operating parameters.

Some embodiments employ past activity and conditions to generate room, artificial intelligence (AI), and participant strategies that may be utilized individually and concurrently to optimize recording of different meeting locations 112/114/116. That is, the processing unit 410 may read conditions and activity previously logged from a meeting to create strategies that can indicate the meeting characteristics of a room and various participants 110. The processing unit 410 may utilize conditions and activity from other meetings, meeting rooms, and participants, which may be characterized as model data, to generate assorted strategies that aid in translating separate recordings into a single virtual environment 104.

It is contemplated that any number and type of equipment settings and capabilities may be inputted into the computing device 102 to be employed by the processing unit 410 to determine what operating parameters are static or dynamic. For instance, a camera may have dynamic zoom, focus, and panning capabilities with static resolution while a microphone may have dynamic gain and signal processing capabilities. The knowledge of the capabilities of the audio/visual equipment in the assorted meeting rooms allows the processing unit 410 to assign operating parameters and adjustments over time that accommodate changing meeting conditions, such as different speakers, participant locations, or equipment inefficiencies.

Information about the various participants of a meeting may additionally allow the processing unit 410 to quickly and accurately identify who is speaking, where they are speaking, and who is likely to speak next. Some embodiments employ artificial intelligence and/or machine learning to translate some participant information, such as name, gender, and age, into strategies that identify, locate, and track the participants during a meeting. In other words, in some embodiments, the processing unit 410 may generate strategies to identify participants based on facial recognition, body language, voice recognition, and gesture recognition that trigger camera and/or microphone operating parameters optimized to accurately capture the participant's involvement in the meeting.

Although the processing unit 410 may operate alone to translate the various input data and information into the assorted parameters and strategies, some embodiments employ supplemental circuitry and hardware to promote efficient, accurate generation and maintenance of the virtual environment 104. The assorted circuitry and hardware may be characterized as modules that are directed to the generation of particular aspects of a virtual meeting. A calibration module 430 may operate to generate a room calibration strategy that tests, detects, assigns, and adapts audio/visual operating parameters for different locations within a meeting room.

The processing unit 410 may also operate with a learning module 440 that generates participant profiles to allow efficient identification of participants in the future. That is, the learning module 440 may operate continuously, or sporadically, to correlate aspects of various participants into known profiles that can be subsequently employed to efficiently and accurately set audio/visual equipment operating parameters. The participant profiles created and maintained by the learning module 440 may allow participant behavior to be predicted, which may allow for proactive equipment operating parameter adjustments to maintain optimal meeting recordings despite changing participant behaviors and activities.

Through the learning about various meeting participants in conjunction with the knowledge of the meeting rooms, the computing device 102 may identify the location of a participant in a meeting room via a mapping module 450. The mapping of where assorted meeting participants are located allows the processing unit 410 to accurately understand the audio and visual conditions associated with the participant's location and consequently set audio/visual equipment operating parameters. The accurate mapping of meeting participants may be particularly helpful when multiple separate cameras and/or microphones are employed to record meeting content. That is, recording meeting content with multiple separate audio/visual components may require computation of operating parameters that is aided by an understanding of the acoustic and/or visual aspects of a particular location in a meeting room.

With multiple meeting participants located in a variety of different positions that may move over time, reassessing a participant's position within a meeting room and adjusting operating parameters may be inefficient. Hence, some embodiments employ an identification (ID) module 460 to assign a unique identifier to each meeting participant, which promotes efficient tracking of participant location over time. It is contemplated that meeting conditions to be presented in the virtual environment 104 frequently change during the course of a meeting. An adaptation module 470 may generate any number of operational triggers, thresholds, and conditions that prompt changing one or more operational parameters. The proactive generation of correlations between operational metrics and consequential adjustments allows the computing device 102 to efficiently adapt to dynamic meeting situations.

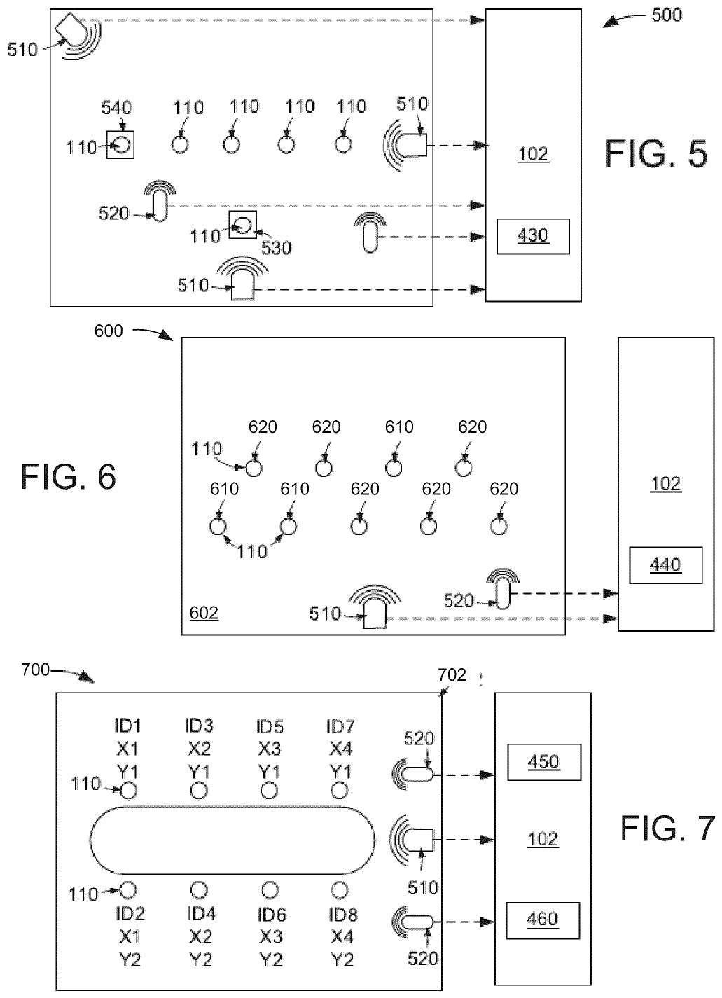

FIG. 5 illustrates portions of a meeting room 500 in which assorted embodiments of an intelligent conferencing system may be practiced. It is noted that a conferencing system, in some embodiments, involves numerous separate meeting rooms that are joined, virtually, by a computing device 102 that translates content recorded from assorted audio/visual equipment into a single virtual meeting environment 104, as shown in FIGS. 1 & 4.

The meeting room 500 is equipped with several separate cameras 510 as well as several separate microphones 520 to record the sounds, actions, and other activity of one or more participants 110. It is contemplated that multiple separate participants 110 are concurrently present in the meeting room 500 and/or a participant 110 moves to different physical locations within the meeting room 500 over time.

The presence of numerous audio/visual equipment 510/520 in different areas of a meeting room 500 can allow for a diverse variety of operating configurations, particularly in the event the assorted equipment have different capabilities or performance criteria. For instance, cameras 510 with different resolutions or zoom capabilities may be utilized individually, collectively, or redundantly with matching, or different, operating parameters just as different microphones 520 may be utilized that have different sensitivities, filters, or beam widths.

Despite the assorted audio/visual equipment functioning, a lack of understanding about the acoustic and/or lighting characteristics of the meeting room 500 may result in sub-optimal recording of meeting activity. For instance, participants 110 with different voices, heights, weights, or accents may provide a sub-optimal audio or video recording despite being located in a location 530 in the meeting room 500 used to test and tune the audio/visual equipment. A participant 110 that stays in one location 530, but talks in different directions over time may also pose risks for sub-optimal audio recordings that produce inefficient virtual environment communications among participants 110. Hence, in some embodiments, the computing device 102 may carry out a room calibration strategy generated by a calibration module 430 at any time to understand the acoustics and visual aspects of different locations within the meeting room.

Some embodiments of a conferencing system execute one or more initial tests of audio/visual equipment may establish optimal parameters for each component and the components as a whole. But optimal operating parameters for audio/visual equipment are often location dependent and potentially participant dependent. It is noted that an initial test may involve any number and types of steps and procedures that produce a default set of operating parameters for each audio/visual component in the meeting room. The establishment of a default set of operating parameters for the assorted cameras 510 and microphones 520 allows the computing device 102, and calibration module 430, to conduct subsequent experiments to understand how sound, light, and movement are recorded within the meeting room 500.

With the default set of operating parameters, or with different operating parameters, the computing device 102 can generate and execute audible and/or inaudible sounds as part of a room calibration strategy to detect how different locations in the meeting room 500 behave acoustically and visually. For instance, in some embodiments, the room calibration strategy may direct various experiments to test how different sounds, tempo, accents, pitches, gestures, wardrobes behave with respect to the audio/visual equipment. As a non-limiting example, test frequencies can be emitted from different locations in the meeting room 500 and recorded by the audio/visual equipment to allow the computing device 102 to analyze the recorded content to discover differences from the test frequency. Such analysis may also be conducted for light as the computing device 102 identifies sub-optimal recordings.

As a result of the experiments conducted as part of a room calibration strategy generated by the computing device 102, an understanding of the operational limitations of the audio/visual equipment as well as how different participant 110 locations, behaviors, and activities are digitally recorded with one or more sets of operating parameters. The computing device 102 and calibration module 430, in some embodiments, may utilize logged system activity, model equipment data, and recorded content to emulate one or more meeting room 500 aspects that contribute to generation of optimal sets of operating parameters for the assorted audio/visual equipment for different aspects of the meeting room 500. Such emulation may utilize machine learning and/or AI to evolve a default set of operating parameters into multiple different sets of operating parameters that are triggered when participants 110 meet predetermined conditions, such as moving to a different location 540, standing up, or a new participant 110 beginning to talk.

The use of AI may, in some embodiments, generate hypothetical sounds and sights that may be utilized to find optimized operating parameters for the various audio/visual components of the meeting room 500. By generating different sets of operating parameters proactively with the room calibration strategy, the computing device 102 may efficiently adjust operating parameters for one or more audio/visual components to optimally record participant activity.

FIG. 6 illustrates portions of an example conferencing system 600 arranged to operate in a meeting room 602 in accordance with assorted embodiments. The conferencing system 600 may be practiced to provide intelligent room calibration within the meeting room 602. The learning module 440 portion of the computing device 102 may carry out aspects of an AI strategy generated to learn about various participants 110. The learning involved with executing an AI strategy may allow the computing device 102 to accurately and efficiently identify participants 110, which may correspond with adjusting operating parameters for one or more audio/visual components in the meeting room 602 to optimize recording of participant 110 behavior.

In some embodiments, upon arrival in the meeting room 602 and detected by the audio/visual components of an intelligent conferencing system, a participant may be correlated to a known profile 610 or an unknown profile 620. It is noted that a known profile 610 may have any number, and type, of information about the meeting participant. For instance, a participant profile may include speech characteristics, such as tone, timing, intonation, loudness, and accent, as well as behavior characteristics, such as propensity to interrupt, use of hand gestures, or talking in a range of directions. Such profile information may additionally indicate a participant's behavior, such as standing up, walking, or hiding their mouth while talking.

It is contemplated that any number, and type, of visual and/or acoustic elements may be utilized to determine if a known profile 610 is present for a meeting participant. Some embodiments may utilize passive cues, such as facial recognition, body recognition, gesture detection, or aspects of a speech, to evaluate if a known profile 610 is present. Some embodiments may employ active cues, such as an answer to a prompted question or direction to stand in front of a camera, to collect data that can be used to determine, with the computing device 102, if the participant is known and has a preexisting profile. In the event a known profile 610 exists, the computing device 102 may adjust for expected speech, behavior, or activities efficiently, and potentially proactively, which provides seamless adjustment of audio/visual operating parameters to optimally record meeting activity.

In some embodiments, if a participant is unknown or has an incomplete profile 620, the computing device 102 may create a new profile by carrying out a predetermined AI strategy generated by the learning module. A non-limiting example of an AI strategy involves the computing device 102 predicting one or more participant characteristic, activity, or behavior before evaluating if the prediction is correct. As greater numbers and types of predictions are correct and based on growing volumes of data collected about a participant, the AI strategy may populate a profile with detected and predicted participant information that is verified over time. That is, the intelligent learning about a participant over time, through execution of the AI strategy, may allow for portions of a participant profile to be predicted and verified later, which can be more efficient and effective use of system resources than waiting for all voice, face, body, behavior, and activity aspects of a participant to be encountered and detected.

As a result of a known profile 610 being present, operational parameters for various audio/visual components can be intelligently selected by the computing device 102. For instance, knowledge of a participant 110 corresponding with a known profile 610 may allow digital filtering of microphones 520, movement of cameras 510, and adjusting recording brightness to provide the most accurate digital recording of the participant. It is contemplated, in some embodiments, that a known profile 610 may allow the computing device 102 to predict activity/behavior, which may then be used to update a profile to provide the most up to date description of the participant's speech and appearance.

In combination with the room calibration strategy that understands the acoustic and/or visual aspects of the meeting room 602, in some embodiments, the computing device 102 may preload, or adjust, various aspects of hardware operating parameters in anticipation of a known profile 610 speaking and/or taking part in the meeting. It is contemplated that, in some embodiments, participants 110 with known profiles 610 and unknown profiles 620 may concurrently participate in a meeting, which may prompt the computing device 102 to choose, or derive, operating parameters for audio/video hardware in an attempt to provide optimal digital recording of the meeting content. As such, the computing device 102 may switch back and forth between multiple sets of operating parameters in response to multiple known profiles 610 and/or unknown profiles 620 being present in a meeting room.

FIG. 7 illustrates portions of an example intelligent conferencing system 700 in which a mapping module 450 and ID module 460 of a computing device 102 operate in accordance with various embodiments to assign unique identifiers to various meeting participants 110 and track the physical position of the participants 110 within a meeting room 702. The assignment of a unique global ID for a participant 110 allows for long-term meeting optimization as different meetings, and meeting rooms, may be streamlined for operating parameter determinations based on the known profile 610 corresponding with a unique global ID.

As shown in FIG. 7, multiple participants 110 are positioned around a common table. In some embodiments, the multiple participants 110 may be assigned both a unique global ID (IDX) as well as a two dimensional coordinates associated with the real-time position of the respective participants 110. It is noted that the mapping module 450, in some embodiments, may additionally assign elevation coordinates. In addition to the tracking of physical locations of participants 110 in the meeting room 702, some embodiments of the mapping module 450 monitor the relationship between the physical coordinates of the participants 110 and the physical coordinates of the various A/V equipment 510/520.

Some embodiments of the mapping module 450 track the location of the participants 110 and correlate those locations with the acoustic/visual characteristics of specific locations in the meeting room. That is, the conferencing system 700 may determine the audio and visual behavior of different locations in the meeting room 702 during execution of a room calibration strategy and assign operational parameters for a camera 510 and/or microphone 520 to accommodate such audio and visual behavior to maintain optimized meeting content recording by the computing device 102.

With the mapping module 450 providing physical locations of participants 110, A/V equipment 510/520, and meeting room locations with audio and visual characteristics, in some embodiments, the computing device 102 may efficiently transition operating parameters of the A/V equipment 510/520 in response to participant 110 movement and activity during a meeting. The conferencing system 700 may, in some embodiments, correlate the known speech, behavior, activity of meeting participants 110 to continually evaluate if operating parameters are to be adjusted to provide optimal digital recording of the meeting.

In some embodiments, a participant 110 may be acoustic and/or visually identified before recognizing the participant 110 has an existing global ID. Through the tracking of individual participants 110 with unique IDs, operating parameters may be efficiently customized and optimized in conjunction with the room calibration information. For example, assorted cameras or microphones may be activated, or deactivated in response to a participant's 110 actual behavior and movement or activity predicted by the computing device 102.

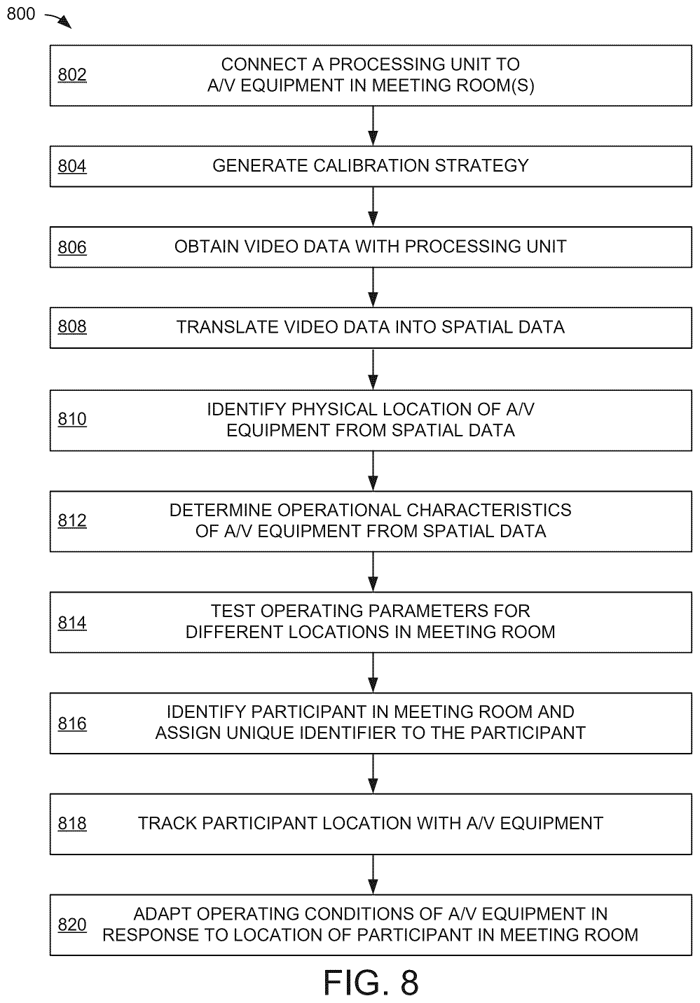

FIG. 8 is a flowchart of an example calibration routine 800 that may be carried out by assorted aspects of a conferencing system to optimize the digital recording of meeting content. Initially, a processing unit is connected to A/V equipment present in one or more meeting rooms in step 802. The processing unit, in step 802, may be physically located in a meeting room, or remotely connected via one or more wired/wireless signal pathways to direct, gather, process, and utilize any number, and type, of A/V equipment, such as cameras, microphones, and sensors.

At any time, the processing unit may generate one or more room calibration strategies in step 804 to prescribe A/V equipment activity to determine the physical location of the A/V equipment in a meeting room, the physical location of objects in the meeting room, the audio/visual behavior of different physical locations in the meeting room, and the operational parameters of the A/V equipment to accommodate the meeting room audio/visual behaviors and characteristics. It is noted that a room calibration strategy created in step 804 may operate autonomously and without the conferencing system having any previous knowledge of the physical locations of the any part of a meeting room.

With at least one calibration strategy in place, in some embodiments, step 806 may proceed to obtain video data from the meeting room via a connection of at least one camera to the processing unit. The video data may then be translated, in step 808, into spatial data by the processing unit, which may employ one or more modules of a computing device, such as the calibration module and/or mapping module. The spatial data may differ from video data in having information indicating an object's location and/or orientation within a meeting room. Some embodiments of step 808 may translate video data into spatial data by defining depth, altering two dimensional aspects into three dimensional aspects, correlating video objects to known dimensions of the meeting room, and filtering multiple video images.

The spatial data, in some embodiments, may not directly identify physical coordinates of meeting room and/or A/V equipment. Hence, step 810 may employ the computing capabilities of the processing unit to utilize the spatial data from step 808 into physical coordinates that indicate the location and/or orientation of objects, such as A/V equipment, tables, chairs, and doors. The spatial data may additionally be employed, in conjunction with a room calibration strategy, to determine the operational characteristics of the individual components of the A/V equipment in step 812. It is contemplated, but not required, that the operational characteristics may be identified in step 812 through a series of tests and/or dynamic operational actions that indicate capabilities, such as field of view, depth of recording, resolution, noise, blind spots, and dead areas.

With the physical locations of objects and A/V equipment mapped into coordinates, in some embodiments, step 814 may test operating parameters for different meeting room locations to determine what parameters provide optimized digital recording of sound and/or video. Some embodiments of step 814 may generate and execute any number, and type, of test with sound, lighting, and A/V equipment operating conditions, such as resolution, zoom, tilt, and beam forming. Some embodiments may test meeting room locations digitally by making a digital twin of a meeting room with the processing unit so that the various objects and A/V equipment are in computed locations within the room. Such digital testing of various meeting room locations for meeting room characteristics and behavior may be aided by one or more artificial intelligence accelerators, machine learning models, and/or supplemental processing units.

The calibration of a meeting room may allow the A/V equipment to efficiently and accurately identify a meeting participant in step 816. Such identification may be from facial recognition, body identification, gesture recognition, voice identification, or a combination thereof. While the identification of a meeting participant may correspond with a known profile that provides participant tendencies, behaviors, and past activities, some instances have the processing unit assign one or more unique identifiers to a meeting participant in response to participant activity over time. Such unique identifiers may allow future identification and prediction of participant behavior during a meeting, which allows for efficient alteration of operating parameters when the participant is active in a meeting.

Next, in some embodiments, step 818 tracks one or more meeting participants with the A/V equipment of a meeting room. For instance, cameras, microphones, and other sensors may be employed individually, and collectively, to determine the locations of the participant in the meeting room. The tracking of participants in step 818 may allow step 820 to efficiently adapt operating parameters of one or more components of the A/V equipment in response to the actual, or predicted, location of the participant in the meeting room. For instance, in some embodiments, step 820 may change zone or more of zoom, resolution, pan, tilt, resolution, and digital filtering in response to where a participant is, or is predicted to be, within a meeting room. As a result, a meeting may employ a diverse range of operating parameters that are automatically triggered by the identification of a participant and the participant's location within a meeting room.

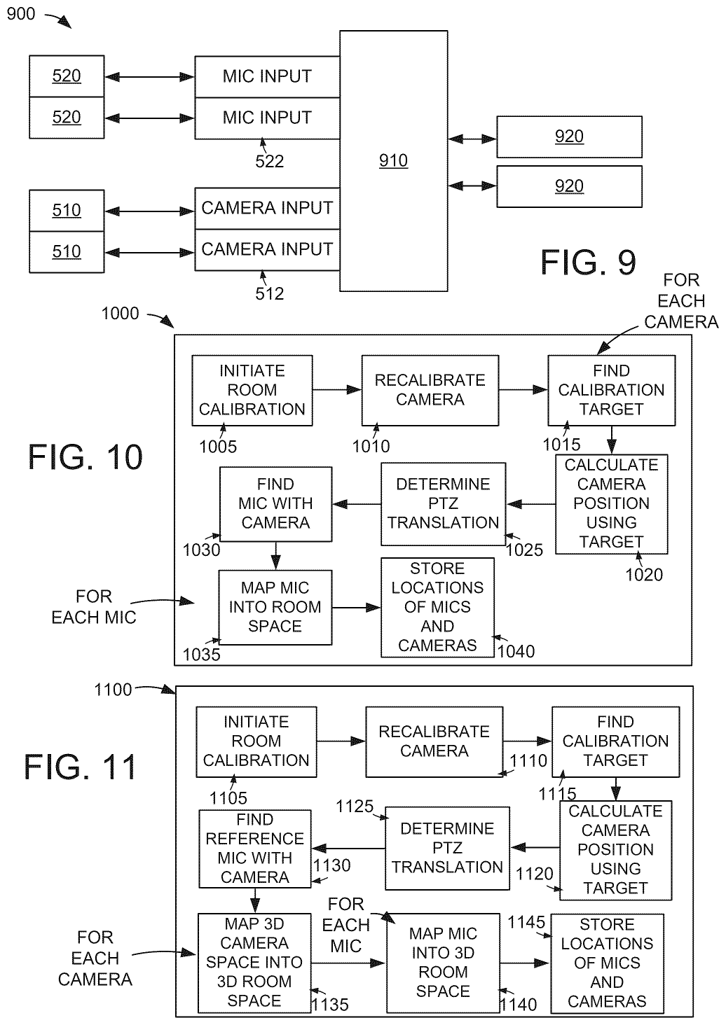

FIG. 9 conveys aspects of an example intelligent conferencing system 900 that may be utilized to carry out a room calibration strategy generated by a computing device 102 in accordance with various embodiments. The conferencing system 900 employs a computing core 910, which may be the processing unit 410 or other programmable circuitry, to translate assorted microphone 520, camera 510, and other sensor signals into digital data that can be used to understand the acoustic and/or visual characteristics of a meeting room at different locations within the meeting room.

As shown, the computing core 910 may be connected to one or more computational, or artificial intelligence (AI), accelerators 920, along with any number of cameras 510, via camera inputs 512, and any number of microphones 520, via microphone inputs 522. In some embodiments, the computing core 910 may offload compute intensive tasks to an accelerator 920. For instance, compute intensive tasks involved in decoding camera video streams and performing the AI video analytics may be sent to one or more accelerators 920. It is noted that the accelerator 920 may be internal, or external, to the computing core 910 and may be any size and type of device with processing capabilities for running software along with hardware, such as a CPU, GPU, or TPU, which are conducive for such compute intensive tasks. Some embodiments of the computing core 910 may execute in a core processor individually, or concurrently, with one or more accelerators 920, which may be external with respect to the core 910. In some situations, the computing core 910 and the accelerators 920 may be included in the same network.

Room calibration refers to mapping the relative location of microphones (e.g., microphones 320/520) and cameras (e.g., cameras 310/510) together into the same three-dimensional room-space. Technical aspects of the present disclosure enable microphones to be located using artificial intelligence (AI) applied to the video output of one or more cameras.

First, each camera 310/510 may use a single microphone 320/520 (e.g., a ceiling microphone, microphone placed on a conference table, and so on) as a reference point. Second, understanding the specific dimensions of the reference microphone, we can determine how microphone 320/520 is oriented relative to each camera 310/510.

Each camera 310/510 (e.g., a PTZ camera mounted to a wall or placed on a surface) may have characteristics that are catalogued, such as a current position of camera 310/510, an orientation of camera 310/510 relative to an external environment, an effective resolution of the image sensor, a field-of-view is needed to determine angles relative to the focal center, image sensor; and zoom profile to learn how magnification affects the effective field-of-view.

A camera 310/510 may scan an external environment to camera 310/510 and camera output (e.g., the captured image and video data of the environment) may be transmitted to a computing device (e.g., computing device 102), where a controller applies a first machine-learned model (e.g., trained to identify certain objects, like a reference microphone 320/520) to the output to identify the reference microphone. The dimensions of the identified reference microphone may be stored within, e.g., computing device 102. In some instances, a microphone 320/520 does not necessarily need to be the reference point; any object (e.g., a camera 310/510, a QR code on a box that is a certain size, and so on) with known dimensions can be the reference point.

Once found, in some embodiments, a second machine-learned model may identify the corners or other extant points of the reference microphone. Once found, the center of the microphone 320/520 may be calculated and camera 310/510 may reorient itself to align the center of microphone 320/520 with the center of the camera's 310/510 field of view. Using a computer vision technique, solve PnP, known geometry of reference microphone 320/520, and camera's 310/510 intrinsic characteristics, the location of camera 310/510 relative to the microphone 320/520 can be calculated.

More specifically, with respect to determining the position and the orientation of the microphone, in some embodiments, solve PnP (perspective-n-point) may be used to identify the center of microphone 320/520, then determine the position and rotation of microphone 320/520 based on known specifications/dimensions of microphone 320/520 Then, using this information, Rvec (rotation vector), Tvec (translation vector), and Rodrigues method, may be used to determine the location and orientation of camera 310/510. Based on the locations and orientations of microphone 320/520 and camera 310/510, a three-dimensional space (artificially created coordinate space) of the room may be generated. In some situations, a microphone that is first located may serve as a reference point. After the perspective and pose of camera 310/510 and microphone 320/520 are known, relative to each other, and microphone 320/520 is the origin (0,0,0) in the artificially created coordinate space, the same method can be applied to other objects within the room to determine how they deviate from the microphone and camera. Triangulation can be used after this process has been performed on three objects.

In some embodiments, a digital twin may be created for every object (e.g., camera 310/510, microphone 320/520, participant 110, and so on) that has been spatially mapped within the coordinate system, and for the people within the room as well. The digital twin of this world can be used to emulate a conferencing environment and a meeting occurring therein, including every camera, microphone, and other conferencing equipment (e.g., computing device 102, speakers, bridging devices, shared displays, and so on), and how a camera may track participants or what objects will be within a frame. In some embodiments, the emulated system may be used to predict what the camera will see if the field-of-view changes. The digital twin will further allow the camera to stay calibrated notwithstanding lens distortions (as discussed below) or movements of the camera itself.

In some situations, the technical aspects of the present disclosure may account for the drifting of an image with respect to a camera lens. For example, in some embodiments, the process may involve mapping of the distortion value between the location of a point on the camera 310/510 lens versus the flatness of the digital image captured by camera 310/510. The distortion value may be based on the curvature of the dome of the camera lens and the flatness of the image, as the camera lens moves from an initial reference point. For example, the distortion is between a pixelated two-dimensional (2D) image of the room captured by the one or more cameras and the three-dimensional (3D) curvature of the camera lens. As the camera lens drifts from an initial reference point where the 2D image of the room is tangential to the 3D curvature of the camera lens, there is a non-linear differential between the image and lens that must be accounted for to accurately map a 3D-representation of the room, e.g., so that the coordinates within this space and the coordinates of objects within this space are accurate and there is a true 1-1 representation.

FIGS. 10 and 11 respectively convey logical maps of processes, functions, and/or operations that may be executed in conjunction with carrying out a room calibration strategy in accordance with various embodiments of an intelligent conferencing system. FIG. 10 shows operations (e.g. processes) 1000 that, in some embodiments, may be conducted if each camera of a meeting room has one or more microphones within its field of view. In various implementations, the process 1000 may include some, or all, of the following operations. For example, in some embodiments, the process 1000 may be implemented by a processing unit (e.g. 410) that is connected to one or more cameras (e.g. 510) and to one or more microphones (e.g. 520). The process 1000 begins at block (or operation) 1005 with initiating a room calibration. At 1010, the process 1000 continues with recalibrating one or more cameras that is in the meeting room. At 1015, the camera finds a calibration target, which in some instances, may be in its field of view. In some implementations, the camera may pan, tilt, etc. to view different parts of the meeting room until it finds, or identifies, the calibration target. At 1020, the process 1000 calculate, or determines, the (or each) camera's position (e.g. in 3D room space) based on the calibration target; for example, a processing unit operably connected to the camera may perform this calculation based on the camera's angle and distance from the calibration target. At 1025, the process 1000 then continues with determining, controlling, or implementing a pan-tilt-zoom (PTZ) translation of the camera, and at 1030, the process 1000 finds (e.g. the processing unit identifies from the camera's image data) a microphone using the camera. At operation 1035, the process 1000 maps the found/identified microphone into room space (e.g. into a virtual 3D model of the space of the meeting room). In some embodiments, as shown in FIG. 10, operations 1030 and/or 1035 may be performed, or repeated, for each microphone in the meeting room. For example, if there are three microphones in the meeting room, then the camera(s) would find each microphone and map the three microphones into the room space. In some embodiments, the microphone-positioning mapping is performed using, based on, or relative to, the camera's position, as calculated in operation 1020. And finally, at 1040, the process 1000 stores the calculated/mapped location(s) of the microphone(s) and the camera(s), for example, in a memory (e.g. 420) or storage device that is connected to a processing unit.

As shown in FIG. 11, the example process, or operations, labelled 1100, in contrast to process 1000, may function to calibrate audio/visual equipment for a meeting room in the event each camera of a meeting room does not have the reference microphone within its field of view. In various implementations, the process 1100 may include some, or all, of the following operations. For example, in some embodiments, the process 1100 may be implemented by a processing unit (e.g. 410) that is connected to one or more cameras (e.g. 510) and to one or more microphones (e.g. 520). The process 1100 begins at block (or operation 1105) with initiating a room calibration. At 1110, the process 1100 continues with recalibrating a camera(s) that is in the meeting room. At 1115, the camera finds a calibration target, which in some instances may be in its field of view. In some implementations, the camera may pan, tilt, etc. to view different parts of the meeting room until it finds, or identifies, the calibration target. At 1120, the process calculates, or determines, the camera's position (e.g. in 3D room space) based on the calibration target; for example, a processing unit operably connected to the camera may perform this calculation based on the camera's angle and distance from the calibration target. At 1125, the process 1100 then continues with determining, controlling, or implementing a pan-tilt-zoom (PTZ) translation of the camera, and at 1130, the process 1100 finds (e.g. the processing unit identifies from the camera's image data) a microphone, in this example, a reference microphone, using the camera. At operation 1135, the process 1100 maps the 3D camera space (e.g. in some embodiments, the physical space viewed by the camera) in to 3D room space. In some embodiments, as shown in FIG. 11, operations 1130 and/or 1135 may be performed, or repeated, for each camera in the meeting room.

At operation 1140, the process 1100 maps the found microphone into 3D room space (e.g. into a virtual 3D model of the space of the meeting room). In some embodiments, as shown in FIG. 11, operation 1140 may be performed, or repeated, for each microphone in the meeting room. In some embodiments, the microphone mapping is performed using, based on, or relative to, the camera's position as calculated in operation 1020. An finally, at 1145, the process 1100 stores the calculated/mapped location(s) of the microphone(s) and the camera(s), for example, in a memory (e.g. 420) or storage device that is connected to a processing unit.

In some embodiments of a room calibration strategy, autocalibration of a room is carried out the identification of a microphone as a calibration target, but rather the camera identifying any object as the calibration target. For example, a calibration target may include an individual, use one or more distinctive visual features of the room (e.g. a table, a chair, a core processor, etc.), and so on, the dimensions of which may be referenced in a database or via the Internet.

Regarding individuals as a calibration target: camera 510 and microphone 520 may capture image data and/or audio data of an individual as the individual enters a room and begins talking. A conferencing system may use the captured image and audio data to localize the camera 510 and microphone 520.

In some embodiments of a room calibration strategy, autocalibration of a room is carried out without human intervention. Such autocalibration may involve a room sweep that catalogues performance and/or capabilities of room equipment, such as microphones, cameras, and sensors. For instance, the pan, tilt, and zoom capabilities may be logged to allow the location and orientation of the room equipment to be ascertained. It is contemplated that, in some embodiments, the extraction of orientation data for each microphone, camera, and sensor in a room may involve aiming a camera at a microphone and utilizing artificial intelligence to identify features of the microphone, such as the winding of the points for a microphone's orientation.

In some embodiments, the orientation of a microphone may occur before other characteristics and/or features are extracted, with or without the aid of artificial intelligence analysis, to provide the correct microphone orientation every time. Calculation of a proper solution for a microphone's orientation may allow assorted vectors to be solved, which may be reversed to determine the position of the camera. The arrangement of the camera, such as pan/tilt/zoom values, may then be used to extract deviations from a room orientation, which may prompt the adjustment of the camera's three-dimensional space orientation.

With an understanding of the position and orientation of the assorted equipment in a room, in some embodiments, a graph may be built for the cameras and microphones that may configure microphones as nodes and cameras as edges. By choosing a primary microphone, in some embodiments, a shelling algorithm can begin by building a table of which microphones are within the field of view of which camera. The shelling algorithm may continue by visiting eligible microphones and cameras of a room, starting with the primary microphone. Executing recursive processing proceeds to remove the primary microphone and the cameras that see the primary microphone from a search while assuming the assigned positions of the primary microphone and cameras are correct.

In some embodiments, a room may be divided into multiple separate virtual spaces with separate, or shared, coordinate plots for various equipment. The ability to selectively separate a room into virtual spaces may allow for optimizations not possible as a single space, such as non-symmetrical rooms or rooms with biased acoustics or light.

Comparison of the list of eligible room microphones and camera to a list of microphones that are in the field of view of cameras indicate which microphone positions and/or orientations need correction relative to the primary node, using the camera as the new origin. Such correction may subsequently allow unevaluated camera nodes to be activated and evaluated, by repeating the recursive processing steps, to adjust and correct any equipment position/orientation. As a result of evaluating all the available microphones and cameras in a room, an accurate coordinate system can be understood to provide locations and orientations relative to selected equipment, such as a primary microphone. Additionally, autocalibration of a room may produce a list of cameras and microphones that cannot be directly tied to a primary microphone as well as produce assorted corrections to observed conditions that allows for the transfer and application between domains.

The calibration of a camera may involve any equipment, steps, processes, and procedures. A camera being calibrated is not limited to a particular construction and may have an image sensor that has a light sensitive component that captures values of incoming light. An image sensor may be situated behind a main glass in a camera body. In some embodiments of a camera, the image sensor is located at the motion center of pan and tilt ranges, which provides a stable series of calculations for relating different pan and tilt values. The resolution of the image sensor may be configurable, but may have a defined native resolution, such as 4 k, by default.

Through binning of adjacent pixels, different camera resolutions may be provided that respectively have diverse arrangements of light, such as linear and/or non-linear arrangements across the image surface. The positional values of rays captured by a camera may not change as the binning may be configured to be even across the image sensor. The spatial relations of a camera may hold and reflect the real world. With the selection of finer camera resolution, better spatial resolution may be provided. It is noted that higher camera resolutions take more time to process and have greater impact on system/network resources.

A camera may be physically controlled by one or more motors. Such motors may be belt driven to provide precise movement, but may be reliant on the belt not deforming, slipping, and not having inconsistencies in wear on the belt surface over time. A camera motor may provide movement that is approximate from current spot. A camera resetting operation may correspond with a reset position that is required for more reliable calibration as the camera movement is calculated from a zeroed position.

Camera movement may be controlled with a quantized range of positions. Cameras may be limited to the full range of movement per model where minimum and maximum motor positions do not overlap. That is, there may be thousands of positions for a camera from −170 degrees to 170 degrees. Some embodiments may map four thousand different camera positions from −2000 to +2000, which may correspond with approximately 1 degree of movement for 14.4 motor positions. Yet, it is noted that a camera motor may not stop in the middle between two positions and, as such, moves between designated positions to provide all aspects of a meeting room alone, or in combination with other, differently positioned, cameras of a conferencing system. However, a corresponding image may overlap. A camera may have a defined set of values that each valid position will map to. It is noted that there is no infinite resolution of movement for a camera.

A camera may employ a lens that is constructed of a translucent material, such as glass, that is consistent across the image surface. It is contemplated that a camera lens may have radial deformation that may be corrected by image processing techniques located on-board, or off-board, relative to the camera. The use of a camera in an intelligent conferencing system may involve networked connections that allow camera control. An example camera control may be via VISCA over UDP. In some cameras, UDP packets for the VISCA do not include the normal headers that are in VISCA. As such, the control packets may be the start with the command.

In the event signal lag is introduced by the network control, such lag may be large enough to affect “real-time” control. Camera movement may have defined range values that change depending on camera and manufacturer. Frame capture for a camera may be conducted by contacting a REST endpoint. It is noted that VISCA does not allow for configuration of resolution, bit-rate, and other configurations

The image captured by an image sensor of a camera may be a byte array that represents a matrix of light/color values. An image sensor may be square with square pixels, and then cropped in different positions per camera. Such cropping may introduce a different focal center that shifts across the camera's movement range. The center of the image may not be the center of the lens, but observed deviations from center may be minimal and most likely are not accounted for. A captured image reflects a snapshot of the current view at a particular PTZ value. Pan and tilt will change the scene in the x-y plane, where zoom will change how much of a scene field of view is visible. As zoom is increased, resolution may stay the same while field of view decreases, but the spatial resolution will increase.

As second order radial distortions in the image are observed, a camera may increase from the center, such as on a 12×80 coordinate system. Distortions may be greater in some aspects, such as a 20×60 coordinate system, and trigger distortion correction. It is noted that distortions between cameras may not have a specific, measured delta, so various embodiments perform per-camera or per-room camera correction. Alternatively, if a general profile can be performed to correct the distortion within acceptable ranges, such correction may be conducted at will.

A camera may have intrinsic characteristics that are built-in the camera itself. One such characteristic is resolution, which may be configurable by a user in 16:9 orientation. Some embodiments of a camera have clarity and consistency that are configurable by adjusting bitrate. A camera may not have a standard aspect ratio natively. Instead, aspect ratio may be compressed. The actual aspect may depend on the crop, which is then mushed/stretched into a standard ratio for transmission.

Another camera characteristic may be focal length, which may be defined as the distance from image surface to most in-focus point in the frame. There are several factors that may affect focal length, such as positions of zoom in its movement range, manufacturing differences, image sensor cropping position behind the lens, lens mount, sensor mount, belt jitter, and mount position. It is noted that the focal length may affect the amount of zoom magnification observed and differences in magnification may translate into differences in field of view.

A camera may have extrinsic characteristics that are to be deciphered through calibration. For instance, camera rotation, which may be characterized as the alignment of the camera in the world from the perspective of the camera, may be determined by calibration. Camera translation is another extrinsic characteristic and may be defined as the position of the world center from the camera's point of view.

In accordance with various embodiments, the world location of audio/visual equipment may be determined and/or utilized. In some embodiments, world location may utilize openCV's SolvePNP function that is fed a series of point pairs, one pixel (X, Y) to one world position (X,Y,Z). As a result, regression and thresholds of SolvePNP may provide the intrinsics needed to take a world position and put a point in a two dimensional image with the assumption that the camera is world center. The matrix can be inverted to give the position of the camera in the world. It is noted that the units of the world chosen in the point pairs is preserved through to the translation and conversion to different units can be performed through dimensional analysis.

Camera control, in some embodiments, may involve tilt correction where the camera accounts for mounting position, but it is assumed that the camera base is parallel to the floor. The selection of a registration object corresponds with the object being centered on while pan and tilt are recorded at the time of the image capture. In some embodiments, differences between optimal world placement and orientation of the camera may be calculated to allow deviations to be calculated. Accordingly, in some embodiments, deviation corrections may be introduced to allow a camera to be world-aligned.

A camera may engage in zoom profiling where deviations from center are assumed to be minimal, but mean that focal center will drift. Characterization of focal center movement may account for such drift, which means that as a camera is zoomed, the center of the image will shift. Various embodiments provide a compensation algorithm that quantifies drift, which allows for efficient drift mitigation and/or elimination. Measurements performed at small deltas may observe the fractional difference between frames. Such measurements may be collected in combination with other camera parameters. For instance, physical camera parameters may include motor position with discrete positions in the movement range, which are linear.

A focal physical camera parameter may include each motor position, which may produce a different focal point and affect the intrinsic aspects of a camera image. Such focal parameter may not be linear and may wholly depend on external immeasurable parameters. A camera magnification may change correspond with field of view changes that adjust as the camera's focal range and intrinsics change. As an example that relates the physical world to magnification, a focal length measurement is not relied upon because it is trying to relate a linear value to a non-linear value. Accordingly, in some embodiments, a process may characterize the curve and produce a translation between motor value and magnification.

Some embodiments of an intelligent conferencing system may employ ray tracing techniques to optimize camera operation. In some embodiments, such ray tracing may assume a camera is pointed at world north, perfectly parallel to the latitude and longitude of the world, and that a camera has a ninety degree field of view in the vertical and horizontal axis. In some embodiments, ray tracing may divide the image into one degree chunks with the center ray at the center of the image is pointed at zero degrees in all directions. From the center up in the image, camera tilt increases and moving down the image means camera tilt decreases.

An image may account for ninety degrees horizontally and ninety degrees vertically, independently. As such, the effective visible plane is −45 to 45 degrees vertically and horizontally. If an XY-plane of this field is overlaid, any point in that plane with an XY position with degrees as units can be characterized. If the position of the image sensor and the size of the sensor is known, then we can calculate how far back our eye is. The eye and the four corners of the imaging plane form a four-sided pyramid that may be extended into the space to form a topless pyramid, which may be characterized as a frustum, and only accounts for the image space that the sensor sees.

Anything visible, whether in focus or not, may be in the frustum. Any ray drawn through the image sensor will be in the frustum and, as such, every pixel becomes a point that can be drawn through. Information that lies between the pixels is lost, which is referred to as angular resolution. Each pixel subset of the frustum is also a frustum. As objects move further from frame, the objects will become smaller and less precise. Center mass of the objects should remain consistent. Subsequently, the center of bounding boxes is chosen for this reason. It is noted that the use of less pixels means less precision. The surface of the image sensor is the closest that an object can be seen and may be referred to as the near plane. Eventually, an object will become small enough to not be seen, which may be characterized as the far plane. As a result, the top and bottom of the imaging frustum may be formed.

For captured images, various data types may be utilized. For instance, an integer data type may be a discrete value natural number that is restricted by the byte representation of the computer. An integer may have a definite range of −2 billion to 2 billion in 32-bit computers. Another integer is a float, which is an IEEE754 defined value to record floating point numbers. It is noted that the numerical accuracy will decrease in precision as numbers get smaller. A distance integer may be characterized as a floating point quantity of distance that is a measure of an origin point to a destination point. Measurements may be in feet for three dimensional spaces and may also be the unit of measure given from the microphone calibration. A pixel may be characterized as a two dimensional integer representation of space while degrees may be characterized as a representation of the angular relationship between different entities in a three dimensional space.

In some embodiments, an intelligent conferencing system may utilize world coordinate systems for a microphone. A microphone coordinate system may be a degree system where origin (0, 0) is directly down. For instance, a cone emitted from the mic down to the floor. If the cone is segmented into 360 positions, 0/360 is the top of the circle and pointed to the north, 180 is at the bottom and pointed south, 90 is pointed west, and 270 is pointed east. The azimuth of the mic is the reading of where in the circle the mic beam is pointed and the elevation is the how far from origin the beam is deviating.

A collider/digital twin is a cartesian space measured in feet where x is defined [−x, +x] to [west, east], y is defined [−y, +y] to [down, up], and z is defined [−z, +z] to [south, north]. Origin (0, 0, 0) in the collider/digital twin is the primary microphone of the space in the ceiling. For a visualizer/ursina, a three dimensional space may be defined with an origin as the middle of the room on the floor with coordinate orientation and units of the digital twin being shared.

For a camera, the PTZ may include an azimuth and elevation, that are measured in degrees deviation from a zeroed position. The azimuth and elevation are relative to the default home position of the camera and may be defined in the datasheet. For example, a NC12×80 camera, azimuth is defined as [−170, 170] where left is negative and right is positive. Elevation may be defined as [−30, 90] where down is negative and up with positive. Zoom may be defined in magnification [1×, 12×]. Practically, the zoom is non-linear and the motor positions are not evenly mapped, which corresponds with each camera having a different upper bound of magnification. Relative camera coordinates, such as azimuth, elevation, magnification, are defined. When translated into world space, a 0, 0, 1× position is zeroed on the horizon of north, with [−azimuth, +azimuth] to [west, east] and [−elevation, +elevation] to [down, up]. It is noted that the origin of a microphone is itself.

For a camera, pixels are the measure relative to the resolution. Pixels may range from [0, 0] to [max width, max height] and may make up the field of view for the camera. The pixels can map to the field of view of the camera to the resolution. X and Y field of view are different, but assuming there is no distortion, then pixels can be mapped to their respective field of views. For instance, [0, max width] to [−fov x/2, +fov x/2] and [0, max height] to [+fov y/2, −fov y/2]. It is noted that the height relations may be inverted, which may carry into most of the relationships and calculations with that include pixels.

A camera may have a three dimensional in-view where the center pixel (pixel width/2, pixel height/2) is used to draw a ray out from the position of the camera and the ray projects into the space along the azimuth and elevation of the camera into the world, which is characterized as the camera space. The local space is relative to the origin of the camera. For instance, north may be the PTZ location of (0, 0, 1×). It is noted that this space is disjoint from the world space. The origin from inside of the camera is the camera while orientation with the world is required to make inferences about the world from the perspective of the camera space.

A local space may be characterized as where local measurements are observed relative to a specific local object. A local space may be disjointed from other local spaces. It is noted that calculations from one space into another may not be performed without very specific inferences about how they relate. An image space may have pixels that provide coordinates in image space. Image space may be a flattened space where the entire world in front of the lens is processed into the image plane of the camera. A frustum may then determine what is captured on the image plane. An image plane may be the near plane, which is the surface of the image sensor. A normal of the image plane may be the center ray into the world where the near plane is orthogonal to the viewer and the size of the plane is the pixel space.

A camera space may be a three-dimensional coordinate system relative to the camera as origin. North may be PTZ location (0, 0, 1×) where the origin is the camera and the normal of the near plane that is orthogonal to the viewer is the ray into the space. Pixels may be mapped to offsets in a field of view with ray origin being the image sensor. It is noted that a ray origin may be characterized as an “eye” that sits behind the image sensor. For instance, an image sensor may be a pane of glass and an eye is the viewer. As such, the field of view is wider, which may be characterized as a pinhole camera model. The camera position (PTZ) will move where the center ray is located. Assuming the camera is pointing at a known location, such as −90 azimuth, 0, 1×, and the field of view of x is 90 degrees, a view may see −135 to −45 degrees relative to the camera north. The field of view of y is 90 degrees and a view may be −45 to 45 degrees relative to horizon. Hence, the world observed by the camera will be in that frustum.

Embodiments that map image space to camera space may utilize the intrinsic matrix that describes the resolution and focal length of the camera sensor. The extrinsic matrix may describe the rotation and translation of the sensor into the world. For instance, a world coordinate of something in the world space may be utilized in the above equation to translate the world coordinate to a pixel (u, v) where w is a depth measure. With the extrinsic matrix and the point only, the point may be transformed to the local camera 3D space. The intrinsic matrix may translate the local point to a pixel space coordinate. By performing the inverse of this relation, in accordance with some embodiments, the two dimensional point may be translated to a three dimensional ray.

Movement between local camera 3D space and world three dimensional space is exact, but depth information may be lost moving from three dimensions to two dimensions. By drawing a line from the eye through the image sensor pixel, a line into the space is produced where a two dimensional point becomes a three dimensional ray. It is noted that the three dimensional ray is still relative to the camera being origin in its local space. As such, rays cannot collide without either moving all rays into the world space, or move one ray into the world space and then into the local camera space.

A world space may be characterized as a common space in which entities live and all local spaces are tied together and relations between those entities can be inferred. Some additional requirements may be needed for specific objects in the world, such as the placement of an object in the space, placement of a camera, and axis alignment. For specific objects, a position and orientation (yaw, pitch, roll) relative to world coordinate system may be employed. For a camera, the camera's local space includes azimuth and elevation deviation from its native north. For instance, rotation of the base of the camera may change the world according to how it spins around and the azimuth of an object in its view has changed.

Changes to the world orientation may affect the local space. For axis alignment, an object's position and orientation in object space must be combined with the world position and orientation to align measurements in the object space to the world space. Once in the world space, relations between different entities can be calculated. Optionally, the results of calculations, such as collisions, can then be moved to object local spaces. It is noted that there are many possible world spaces, such as a simulation of world space where collisions are performed or a display world space in the visualizers.

A camera may employ distortion correction, in some embodiments. A camera may be configured in a variety of configurations, such as radial, barrel, pincushion, and mustache arrangements. A camera may have perspective/skew as well as frustum/near plane where the focal length to distortion may equate to: [short, long]−[warped, not warped] where short is a warped perspective that corresponds with near stuff being nearer and far stuff being farther while long is where near and far are able to be compared using size while near and far are not distorted.

A camera, in some embodiments, may have axial magnification while a microphone, in other embodiments, may have reflections and collisions between rays. Such collisions may be processed with one or more algorithms. For instance, drawing a ray through pixel may correspond with a world axis-alignment being assumed. A pixel position may have a specific location (u, v) where u is x offset and v is y offset. A resolution may be defined with a width and height where height and width are pixels. A PTZ location may have p, t, z values where p is between 0 and 360, t is between −90 and 90, and z is between 1×-max. A field of view may have fovw and fovh values with 90 degrees in both height and width. Scaled field of view may be based on magnification with scaled_fovw and scaled_fovy equates to fovw/z and fovh/z.

In embodiments that find a perspective matrix, field of view perspective matrices scale with field of view and allow for custom ratios based on height and width. Infinite matrices may allow for calculating a depth of field at infinite focal length, which allows for correct perspective at a long focal length. Reversed perspective matrices may spread small fractional values for better precision. As a result, field of view perspective, reversed infinite field of view perspective, and infinite field of view perspective may be provided to find a projection. An invert projection may be used to get base rays from camera with a point having a specified location, such as x, y, 1, 1, a perspective matrix, a projected point, a projected ray, and a normalized projected ray.

Some embodiments of a camera move a ray from camera local to world space with tilt, rotate, or combinations thereof. For tilt, a rotation matrix moves a point around an origin with all points calculated as local to the camera with the camera as origin. Therefore, changes will happen around the camera focal origin. For rotate, the same origin rotation as tilt may be utilized with rotation happening around an origin. In situations where tilt and rotate are chained together, order is important between the rotations and tilt is applied before rotate.

In ray-ray collider embodiments of an intelligent conferencing system, the shadow of a point over a line segment will produce some point from origin to the extent of the ray in the direction d. The shadow of the point on the ray can be calculated with the dot product. Linear interpolation may be defined as a starting point and some percentage of a value. For instance, 0% can be the starting point and 100% is the end point where end equates to start in addition to the full extent. In the case of a point and a line segment, we want a ratio of point and line segment calculated with the new orthogonal directions for each ray with one ray the z-axis whose impact is nullified.

Use of point origin of the other ray as the point allows a shadow to be cast onto the new coordinate system's x-axis. If the line segment length, along the x-axis, is 0, the lines are parallel and coordinate system can't exist. If t is computed to be negative, the point is behind the ray origin. The process may be reversed to get the point on the other ray. A line from the respective points allows for the computation of the midpoint, which can be defined as a “collision.” The distance may be defined as the length of line between the two points. Variable t is the ratio of the one unit orthogonal to a direction compared to how large the other ray is in that direction. The variable t is a proportion of how big a ray distance is compared to how big one unit is in that perspective.

For embodiments of an axis-aligned camera collider, an axis can be defined before a point on ray 1 of crossing is found and a point on ray 2 of crossing is discovered. From there, a length and midpoint are respectively found. In a homography-based collider, an implementation of a two point collider may be utilized. It is contemplated that point filtering strategies may be employed. For instance, a length-based filter may find the collision info for selected points to allow for the calculation of the length and threshold the values based on a maximum allowed length between the points. Another instance provides, grouping after exhaustive ray collision set between all cameras and bounding boxes, where the points are grouped based on a maximum allowable distance. With all collision points taken into account, the points are spatially sorted to determine if points are very near, which triggers the grouping of those points.

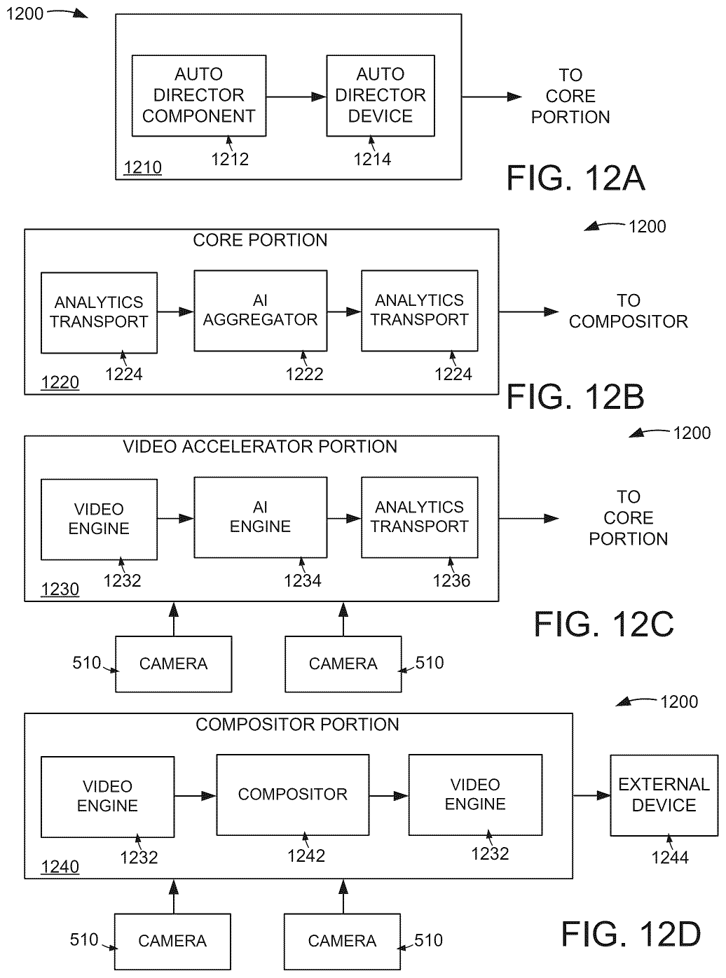

FIGS. 12A-12D respectively illustrate a block representation of portions of an example conferencing system 1200 that may be utilized to provide intelligent calibration and optimized digital recording of a real-world meeting in a virtual environment 104. In some embodiments, the system 1200 may have a designer portion 1210, as shown in FIG. 12A, that operates to decode video streams and administer AI along with assigning a compositor operative to a bridging device. The designer portion 1210, in some embodiments, may have an auto director component 1212, and/or a control panel, that interacts with an auto director device 1214, in some embodiments, to assign operatives to devices, such as core or peripheral devices. The auto director device 1214 may decode and execute AI on video streams, which may occur with one or more AI accelerators. It is noted that a core processing unit may execute aggregator and rules engine aspects of the system 1200. In some embodiments, the auto director device 1214 may assign compositor operatives to one or more bridging devices.

From the designer portion 1210, design information flows to a core portion 1220, as shown in FIG. 12B. The core portion 1220 of the system 1200, in some embodiments, provides an AI aggregator 1222 sandwiched between analytics transports 1224, which may be characterized as runtime engines, which may supply a compositor via a rules engine core operative. In some embodiments, the core portion 1220 may have one or more analytics transports 1224 that operate with an AI aggregator 1222, as shown. In some embodiments, the core portion 1220 may comprise camera operatives, camera supervisors, and link operators.

One or more video accelerator portion 1230 may provide the core portion 1220 with data that is configured with decoded video. As shown in FIG. 12C, any number of cameras 510 may input into video engines 1232 that feed AI engines 1234 and, eventually, an analytics transport 1236. In some embodiments, the video accelerator portion 1230 may configure video and AI engines as well as create analytics transport pathways to the core portion 1220. A camera 510, in some embodiments, may feed data to a compositor portion 1240 where a video engine may decode such data. A compositor 1242 may be employed to output data to an external device 1244, such as the computing device 102 shown in FIG. 12D.

The compositor operative aspect of the compositor portion 1240 may, in some embodiments, receive composition data and configure one or more video engines to operate with a compositor to output encoded video to a computing device 102. Various embodiments execute an AI pipeline on the video accelerator to offload heavy computational processes from the computing device 102. In some embodiments, software applications allow a user to design an audio, video, and control setup that is stored in a file. Such a setup can include the specific AVC equipment, such as a microphone, camera, or sensor, and the digital signal processing settings, such as AEC, to be performed on data captured by each. This file will be sent to the core portion 1220 so that the core portion 1220 understands which equipment is in the setup and how to process the data.

Various embodiments of an intelligent conferencing system have a software application receive instructions that the AI accelerator will be included in the equipment setup. The AI accelerator may process data as part of the equipment setup, which the aggregator and rules engine operate within the core portion 1220, and that the compositor and operative are assigned to the bridging device.

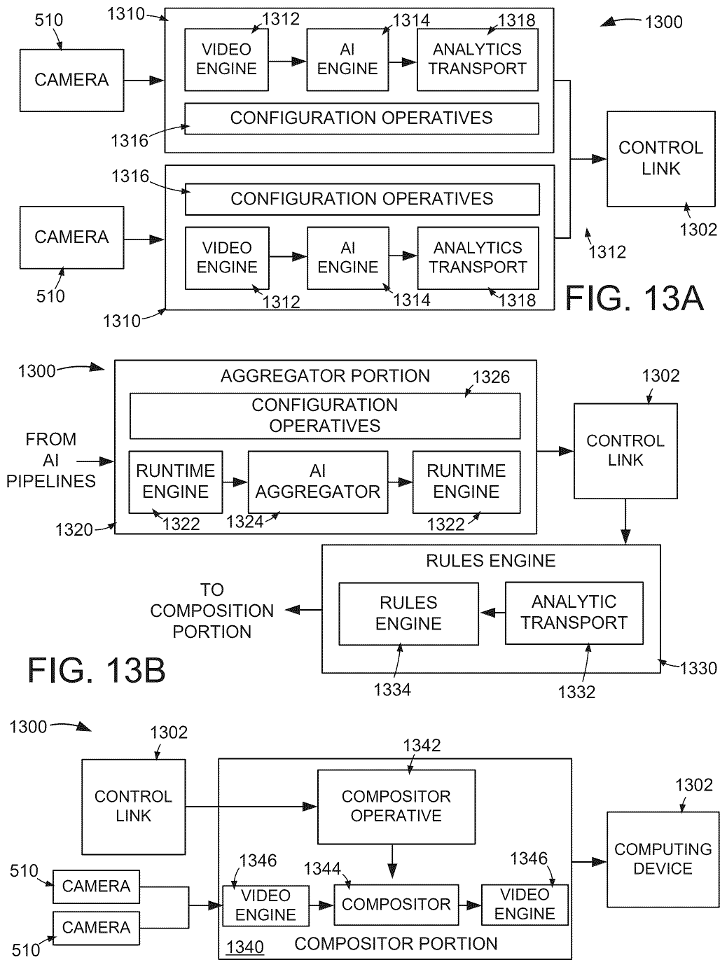

FIGS. 13A-C respectively illustrate block representation of portions of an example intelligent conferencing system 1300 that may operate in conjunction with the conferencing system 1200 of FIGS. 12A-12D. FIG. 13A displays an example of how individual AI pipelines 1310 may input camera 510 information to one or more video engines 1312 and AI engines 1314 to provide configuration operatives 1316 that may offload heavy computational processes, such as decoding and running inference on video frames. In some embodiments, the AI pipelines 1310 may employ a runtime engine as an analytics transport 1318 that feeds analytics information to a control link 1302.

It is noted that any number of individual AI pipelines 1310 may operate in parallel and may supply an aggregator portion 1320, via the control link 1302, data that is intelligently aggregated and transported to a rules engine portion 1330, via another control link 1302, as shown in FIG. 13B. In some embodiments, the aggregator portion 1320 may employ runtime engines 1322 and AI aggregator 1324, along with configuration operatives 1326, to supply analytics information to the rules engine portion 1330. While not required, the rules engine portion 1330 may operate a runtime analytics transport 1332 and rules engine 1334 to supply analytics information to a control link 1302.

FIG. 13C displays an example of how a number of cameras 510 may input video data into the composition portion 1340 while the control link 1302 feeds analytics information to a compositor operative 1342. In some embodiments, a compositor 1344 may utilize data from a video engine 1346 and from the compositor operative 1342 to allow debugging and demonstration functions via a server portion 1348. The compositor 1344 may, in some embodiments, additionally provide output video data via one or more video engines 1346

In some embodiments, a control link may supply a composition portion 1340 with aggregated data that is fed to a compositor where decoded video is supplied in order to output encoded video to a computing device 102. It is contemplated that, in some embodiments, debugging, or demo, operations may also be conducted in the composition portion 1340. In some embodiments, the compositor aspect of the composition portion 1340 may be executed on a video accelerator to balance system 1000/1100 resources during some events, such as decoding, cropping, or scaling video data. The compositor 1344, in some embodiments, may operate on a video accelerator to offload heavy computational processes, such as decoding, cropping, and scaling.

For clarity, a runtime engine may be characterized as the process which manages the design running on all devices of an intelligent computing system. The runtime engine may instantiate individual objects, commonly known as operatives, which control and configure different parts of the system. For example, there are operatives to control and configure different parts of the auto director pipeline shown in FIGS. 13A-C, such as video engine, AI engine, analytics transport, aggregator, rules engine, and compositor.

A control link may be characterized as providing a flexible method of communication between objects within the runtime engine, whether objects are running on the same machine or across the network. The analytics transport, in some embodiments, is the transport layer which allows the different parts of the Auto Director pipeline to be either distributed across the network or run within the same machine. The analytics transport leverages the existing control link infrastructure to transport analytics across the different parts of the pipeline whether the pipeline is distributed across the network or on the same machine. The analytics transport uses an existing database, or library, which may use UDP sockets to stream data between processes and control link portions of an intelligent conferencing system.

Configuration operatives may be characterized as objects running in the runtime engine that are used to configure and control the different parts of the Auto Director Pipeline. An AI pipeline may be characterized as an analytics pipeline which decodes and analyzes a single camera stream then transmits the analytics to downstream clients. A video engine may be responsible for decoding and serving raw video frames to an AI Engine. The non-limiting example shown in FIG. 10 shows how a camera provides a mediacast stream which is simply a RTSP/RTP H.264 video stream.

An AI engine may be characterized as an application that analyzes a single camera stream, using a collection of different models, such as face detection, head pose, liveness, speaker identification, and face tracking, before transmitting the results via the analytics transport. The AI engine may be implemented in two languages, C++ and Python. The C++ portion receives video frames from video engine, executes a colorspace convert, and moves the frame into CPU memory space. Once the video frame is formatted, the AI engine will hand that frame to the Python portion, which may be characterized as CV Analytics Pipeline, via API call into Python module. The Python module then runs inference, collects analytical data, and passes that on via IPC mechanism off to next stage in pipeline which is AI aggregator.

An aggregator may be characterized as the application which correlates all the individual camera analytics and the spatial information to identify unique meeting participants and active talkers. Combining three dimensional positions of participants as well as finding similar facial features, such as facial descriptors, across multiple cameras and mapping them together to identify unique people, the aggregator can identify unique people between all camera streams. Aggregator may then transmit the results, via the analytics transport, downstream to the rules engine. A spatializer, in some embodiments, uses the two dimensional position of a bounding box, or its center, in each of the camera fields of view along with the room calibration data, such as geo-location of each camera.

A global tracker pipeline (GTP) may use face descriptors across camera stream to determine which faces are likely to be the same person. A rules engine may be characterized as hardware and/or software that determine the meeting participants and the view to send to the hosting application. The rules engine may use the results from aggregator to determine which participants should be included in the final composition as well as the best camera view to provide for the participant. The rules engine then creates a composition configuration which defines the placement and views of meeting participants, and meeting room views, in the final composition that is sent as JSON to the compositor via a control link.

Various embodiments of a compositor may use the results from rules engine to create the final composition output frame. The composition configuration provides all the information required for the compositor to create final composition including which camera streams to use for each participant in the composition. In some embodiments, the compositor will configure a video engine to stream every camera view that is required in the final composition, then read in the frames, crop, scale, and place the cells in the output frame. The compositor, in some embodiments, may then make the output frame available to any interested client, such as the USB stack.

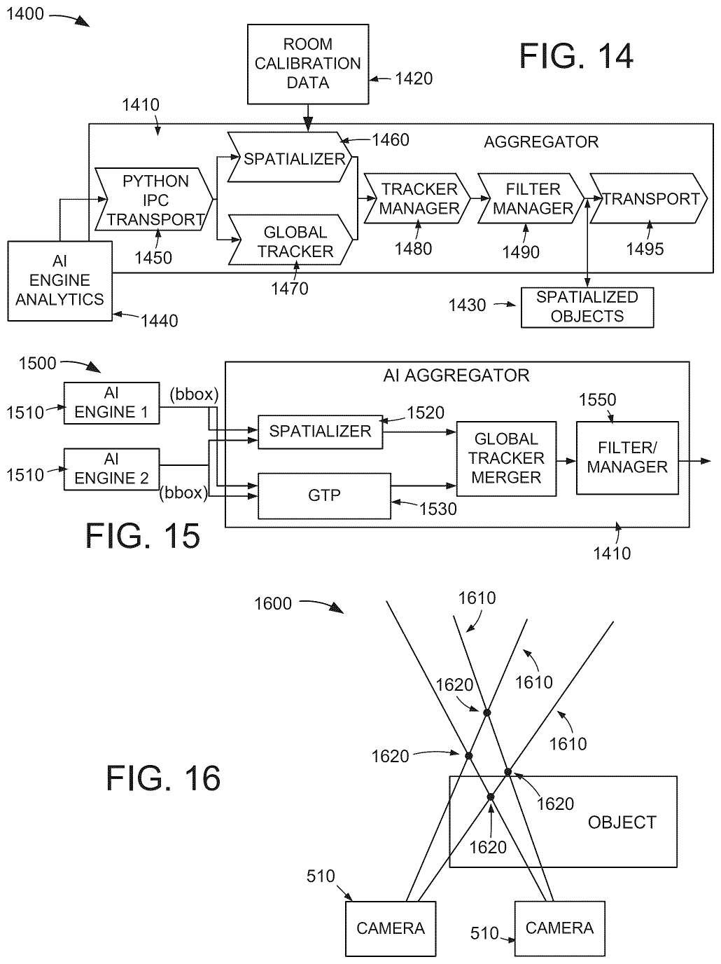

FIG. 14 illustrates an example functional block representation of aspects of an example conferencing system 1400 configured in accordance with various embodiments to employ intelligent calibration. In some embodiments, the system 1400 may have an aggregator 1410 that utilizes room calibration data 1420 and spatialized objects 1430 to assign a unique global identification to each meeting participant 110. The aggregator 1410 may provide a combination of global tracking and spatialization of objects. In some embodiments, the role of the aggregator 1410 is to accept multiple telemetry streams from the AI pipeline and then transform those streams into a series of uniquely identified, trackable, and spatially located objects. It is noted that assigning and maintaining a consistent global ID to a participant 110 in the 3D room space provides information that allows for the optimization of translating an actual meeting into a virtual environment 104.

In order to simplify the solution space, some embodiments do not physically move a camera after initial calibration. As a result, dynamic error or active tracking across dynamic PTZ movements may be eliminated. It is noted that the solution space is to be bound by known walls, which contrasts a meeting happening outside on a parking lot with infinite distances around everything. In some embodiments, the system 1400 may initially start by assuming a rectangular shaped meeting room whose dimensions are directly known. The system 1400 may then attempts to infer a solution space by camera positioning where possible.

While microphone, and other acoustic sensors, may be utilized in some embodiments to locate participants 110 in a meeting room, other embodiments may solely employ cameras to locate participants. An intelligent conferencing system 1400 may rely on AI, camera lens corrections, homography, and an automatic setup, but there are many sources of potential error that are not eliminated despite ideal camera placement, quantity, or setup. In essence, in some embodiments, the system 1400 may estimate where objects are in a three dimensional room space until such location is verified. Hence, in some embodiments, every participant 110 location may be assigned a confidence score indicative of how accurate the location estimates are. Two powerful contributors to a solid confidence of participant 110 location determination involve position and quantity of cameras and facial descriptors from AI.

For systems 1400 with a single camera, in some embodiments, a two dimensional flag is passed and active talker detection subsequently verifies, or alters, the assigned location within a meeting room. In the event two or more cameras are utilized, participants 110 can be more accurately located within a meeting room. The best case scenario for detecting facial descriptors of assorted participants 110 comes when a face forward view is present in multiple cameras, which corresponds with very strongly correlated descriptors. However, such face forward view may need the cameras to be close together, such as a very acute angle between them to provide a stereoscopic configuration. Yet, such arrangement is the worst case scenario to use computer vision to locate and verify a participant.

The best case scenario for using multiple cameras is when they are roughly 45° apart. As two cameras get wider and wider apart, the confidence of the face descriptors gets worse and worse. It is noted that a view of a participant from front and back cannot use descriptors to narrow down the global ID, but the confidence of the camera view gets better and better. With more than two cameras used to locate a participant 110, it is likely that many meeting participants 110 will be observable in multiple camera fields of view. The combination of multiple cameras yields better triangulation as well as more views of the face to get better descriptors.

In some embodiments of the intelligent conferencing system 1400, the output of the aggregator may be frame by frame, or inference by inference, global object centric, spatialized (3D located), filtered data frame that is then passed via IPC to rules engine. In other words, the aggregator may transform multiple video streams of camera centric data that contains individual annotated objects into a three dimensional object centric focused data stream that references camera feeds. For every participant 110, the aggregator, in some embodiments, can provide a global ID that is a unique identifier tied to a specific participant in the room. Such an identifier may remain ‘in play’ throughout the duration of a meeting. The aggregator, in some embodiments, may provide a binary flag that is the aggregation of the output of the liveliness detector. It is noted that each camera ID may have a ‘is real’ flag that is set when the participant 110 has a known profile 1110 and is found to be a real human, as opposed to a photograph, poster, or projection.

Various embodiments of the aggregator may provide a binary flag set if a three dimensional participant 110 location cannot be accurately ascertained, or not enough cameras are active. In some embodiments, the room coordinates of the centroid of the detected participant 110 may be provided by the aggregator as well as the radius of the sphere, which helps understand head size. In some embodiments, the aggregator may provide an aggregation of the AI based talker detection, the head pose for each camera, and the camera/face bounding box pairs for each camera and global ID, which may be passed through.

It is understood that data coming from analytics may be jumpy, bouncy, and occasionally just plain wrong. For example, between two frames of data, a bounding box can ‘leap’ across the room. Hence, the goal of the filter engine is to work with spatializer and global tracker to stabilize the data. In some embodiments, some data can be simply smoothed in a feed forward sense, such as reducing the jitter of a bounding box. In some embodiments, data can be better controlled by establishing a closed loop filter of sorts around the system 1400. Various embodiments may utilize Kalman filtering to handle with noisy and/or missing data by predicting the present state based on a model and all previous states, then use the actual measured state to update.

For every detected face, facial descriptors are mathematical representations of how a particular AI model “sees” a human face. In other words, a facial descriptor may be a unique array of vectors that are unique for a given human face. To obtain a facial descriptor, a face may be identified, in general, then predicted where general features are located, such as eyes, mouth, and ears, which allows an AI model to create descriptors. Such descriptors of the face may be passed into a GTP. Then for every face across every camera stream GTP measures the cosine distance from the descriptors. Descriptors that are very close are more likely to be part of the same face.

Ultimately as a result, close descriptors get the same global ID. Unlike GTP that uses the descriptors from the AI engine, in some embodiments, spatializer uses the two dimensional position of a bounding box, or its center, in each of the camera fields of view along with the room calibration data (geo-location of each camera). In some embodiments, for every bounding box in every camera field of view, a ray may be projected from the camera center through the bounding box into the three dimensional space. The intelligent conferencing system 1300 may then look for intersections of the rays in the space. If a participant 110 is visible in multiple cameras, such as 45 to 90 degrees apart, accurate facial descriptors may be generated, along with accurate positional data, which corresponds with a high score. As a confidence score increases, an indication increases that there is indeed a real person in the real space at that spot. Such a confidence score may involve weighted, or non-weighted, camera observations, such as angles between cameras, resolution of a face, facial descriptors, and AI models aspects, to calculate a score that indicates how confident the system is in the known profile 610.

It is noted that a spatializer may not reliably uniquely identify a participant in a meeting room. The closer two cameras are together, the worse the spatializer may be, which may correspond with a lower confidence. That is, the math involved that resolves position requires a bit of separation due to the infinitesimal points without regard for head distance, at least in the most native implementation. Angles of difference matter in such a case. For instance, along a long straightaway of a train track, a bright train light would be difficult to judge for distance, but an off-center vantage point from the train track would make distance ascertaining much more efficient and accurate. Hence, you can either move perspective wider or you can, instead, see the whole front face of the train, which can better estimate how far the train is from that spot on the track.

If a participant 110 is visible in two, or more, camera streams, but the face is only visible in a single stream, GTP may not work reliably. Accordingly, a unified tracking module (UTM) may be configured to receive input from both spatializer and GTP and resolve the most likely ground truth for the room. For instance, in some embodiments, a combination of the confidence of a person's presence in a meeting room with detected, or derived, facial descriptors allows for improved tracking through differentiation and disambiguation. In other words, two participants that are sufficiently close that they resolve in the camera to a common position would be differentiated, in some embodiments, by using facial descriptors to tell that one known profile 610 is located separately from another known profile 610. Such differentiation allows the system to make more accurate audio and/or video setting adjustments when the closely positioned participants speak, gesture, or move.

The product of combining participant location with facial descriptors is increased confidence. As such, one model may operate by using facial descriptors, but is inaccurate in the event the same face is not clearly visible in multiple separate cameras. Conversely, if two cameras are located at near the same spot, or if there is only one camera, the system cannot accurately resolve ‘depth’ into the meeting room. Just as a human loses depth perception if they close one eye, or only have one eye. The wider ‘eyes’ are apart, the more accurately, and confidently, a system can determine the geometric position of items in a meeting room.

If a system finds an item in multiple camera views and then calculate that the item occupies a single physical space, the system may have a high confidence that it is the same item in the respective camera views. Accordingly, as one model gets less confident, the other model gets more confident. The output of GTP should give a mapping between individual ID and bounding boxes along with a confidence that a list of bounding boxes belong to the same person.

As shown in FIG. 14, in some embodiments, an AI engine analytics module 1440 may provide information to the aggregator 1410, and specifically to a transport 1450, such as a Python IPC transport that facilitates supply of information to a spatializer 1460 and a global tracker 1470. While not required, various embodiments may utilize a tracker manager 1480 and a filter manager 1490 to organize and execute the tracking of participants 110 as well as filtering audio and/or video streams. One or more transports 1495, such as a Python IPC transport, may be employed by the aggregator 1410 to further distribute information to provide an efficient and accurate virtual meeting.

FIG. 15 illustrates an example logic map that may be carried out by various embodiments of an intelligent conferencing system 1500. In some embodiments, aggregator 1410 may input data from any number of AI engines 1510, such as the AI pipelines 1310, that feed both a spatializer 1520 and a global tracker pipeline (GTP) 1530. In in some embodiments, the spatializer may be a python module that takes in head bounding box (bbox) information from all cameras' AI engine/perception pipeline before determining who are the same people across camera streams and outputs the three dimensional location of those people. In some embodiments, the spatializer may be a member of the aggregator block.

In some embodiments, the spatializer may correlate people across camera streams. In other embodiments, facial embeddings in the global tracker pipeline may be used to correlate people to camera streams. One major advantage of using spatializer, rather than facial embeddings, is that it works when only the back of someone's head is visible, which is when facial embeddings would fail. On top of correlating people across camera streams, in some embodiments, the spatializer may provide the three dimensional locations of the people, which has a variety of potential uses, such as being leveraged by rules engine, assisting in tracking people through time, or other creative uses, such as accurate counts of people in a given space.

In some embodiments, the spatializer may use the three dimensional locations of the cameras, as defined relative to a microphone, which are obtained by executing portions of a room calibration strategy. The room calibration information may be then employed to create a method for projecting rays from a camera's 2D image into 3D space and determining 3D collision points with rays from other cameras.

FIG. 16 illustrates a top view representation of portions of a meeting room 1600 where assorted embodiments of a conferencing system may be conducted. An issue encountered with use of a spatializer is the reliance on the assumption that if two rays 1610 collide in 3D space that indicates that the two boxes 1620 where the rays intersect must represent the same person. However, it is possible for rays to coincidently collide even if they do not come from bounding boxes that represent the same person. Furthermore, if the cameras 510 and people are coplanar then extra collisions can occur and it will become mathematically ambiguous which collisions are the real people and which are false positive collisions, as shown in FIG. 16.

The result of false positives caused by both coplanarity and random chance is the possibility that large amounts of false positive points exist. In order to differentiate which collisions are real people and which are false-positives, some embodiments assume that each ray 1610 should only collide with one other ray from each other camera in the room. That is, it would not make sense for a person visible in a first camera 510 to be visible in two different places in a second camera 510. As such, only certain sets of possible real collisions can satisfy this rule for every ray. Then, the system may be configured to differentiate between which collision along a given ray is most likely to be the real persons location providing a depth estimation that allows for the accurate projection of that distance along the ray in 3D space. Then, whichever collision is closest to that location is most likely to be the real person, and the rest are most likely false positives.

Embodiments may utilize the computed depth estimates to select collisions that are closest to our depth estimates. Once a collision is selected, in some embodiments, a system may assume all other collisions along either rays that composed it are false positives. Accordingly, the system may use of assumptions to select the collision that we have the highest confidence in first while eliminating collisions that the choice disqualifies and moving down the list of confidence. The intelligent elimination of false positives with the spatializer may result in preliminary clumps of valid collisions that must be sorted to provide accurate location of meeting participants 110.

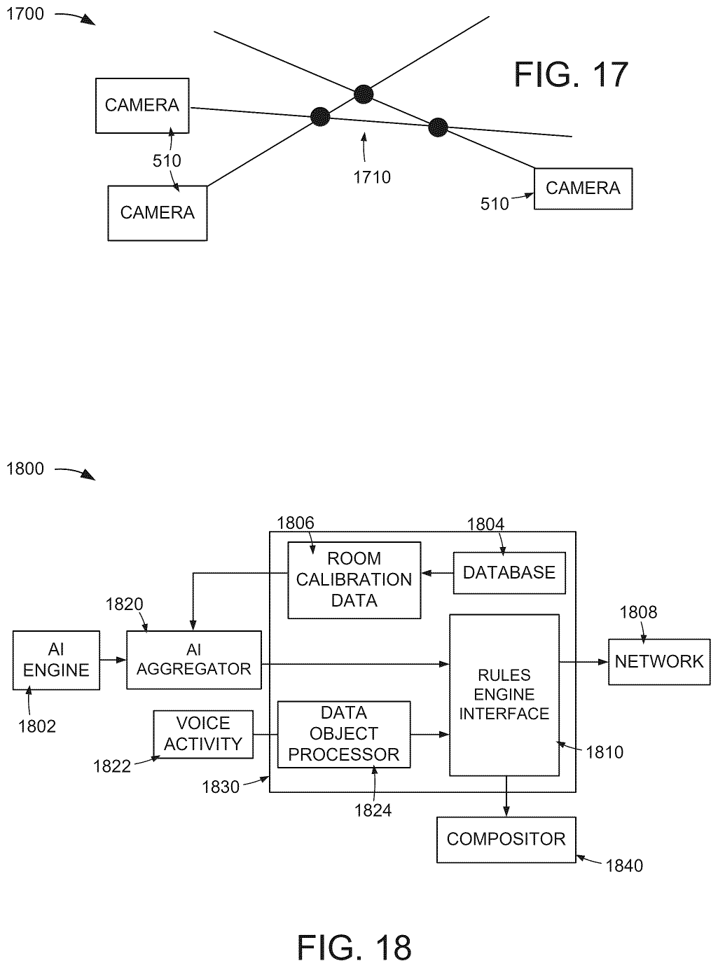

FIG. 17 displays portions of an example conferencing system 1700 operating to eliminate areas of valid collisions 1710 in accordance with some embodiments. The area of collisions shown in FIG. 17 is a person who is actually represented by three collisions 1710 resulting from the meeting participant being the only in the room who has a box capturing them in all three camera streams. Therefore, there is a valid collision 1710 between a first camera and a second camera, between the first camera and a third camera, and between the second camera and the third camera. Accordingly, in some embodiments, common origin rays may be employed to determine that this is one participant and to select a point in the middle of the area as the participant's singular location. As a result, the spatializer has completed its task and is ready to send out the location of each meeting participant in the meeting room.

FIG. 18 illustrates a functional block diagram of portions of an example conferencing system 1800 that carries out assorted embodiments to provide optimized audio/visual recording and reproduction. In some embodiments, a rule engine interface 1810 may help to exchange data between the rule engine to auto director operative and vice-versa. In some embodiments, the rule engine may be used to create a composite frame of the participants in a meeting and do so in an aesthetic, intelligent manner. For instance, the system may generate one or more virtual cells from camera images and provide that cell as part of a virtual environment that represents a meeting. It is noted that a cell may be dynamic and change as conditions, participants, and/or meeting subject matter change over time.

In some embodiments, the interface may function as a non-blocking call that makes all interface transactions asynchronous methods. On each transaction, the callback function may be called back on the response from the rule engine and this callback is registered on initialization time or can be overridden. Various embodiments may execute rules in a node environment which allows us to run the rule engine anywhere from the core, remote workstation, in the cloud, or other suitable location. In some embodiments, the rule engine may provide an API request handler for each rule engine interface that performs the required action. On each request handling, all the actions may be performed in sequential order, which can be characterized as horizontal flow, and such requires previous iteration data or stored data such as layout manager, camera configuration, and composition list, which can be characterized as vertical flow.

In some embodiments predefined templates may be employed. Such templates may be based on multiple scenarios, such as meeting type, size of the room, and number of cameras used in the room. This makes it easier to install auto director in a new setup and for customization simply choose a matching template to start customizing for their need. Given the end-user's perspective, attention could primarily be directed toward customizing the layout, overlap handle, assignment of a participant, and feature customization. For the layout, layout cell placement and size may be addressed as well as animating cell changes for cell, such as created, removed, updated, replaced, swapped, or resize. For feature customization, attention can be directed to focusing on a person/conference talker, the presentation mode, and who is the current active talker.

In some embodiments, the conferencing system 1800 may be configured to utilize any number of AI engines 1802 that feed an AI aggregator 1820. In some embodiments, a database 1804 and room calibration data 1806 may collectively feed the AI aggregator 1820 to allow data to input an auto director portion 1830 where the rules engine interface 1810 is employed to output information to a network 1808. The auto director portion 1830 may, in some embodiments, supply voice activity 1822 to a data object processor 1824, stabilizer, and filter that feed a current view list and view list interface before inputting information into the rules engine interface 1810.

Embodiments of the auto director portion 1830 may supply information into the rules engine interface 1810 with a camera supervisor operative and camera information interface, which may supply information to a network 1808. Any number, and type, of sound activity may be detected and input into the auto director portion 1830 where an active talker correlator may process the data and feed a talker prioritizer and talker priority interface, which supplies information to the rules engine interface 1810. In accordance with various embodiments, the auto director portion 1830 may have a layout response interface that feeds a compositor 1840 as well as the rules engine interface 1810.

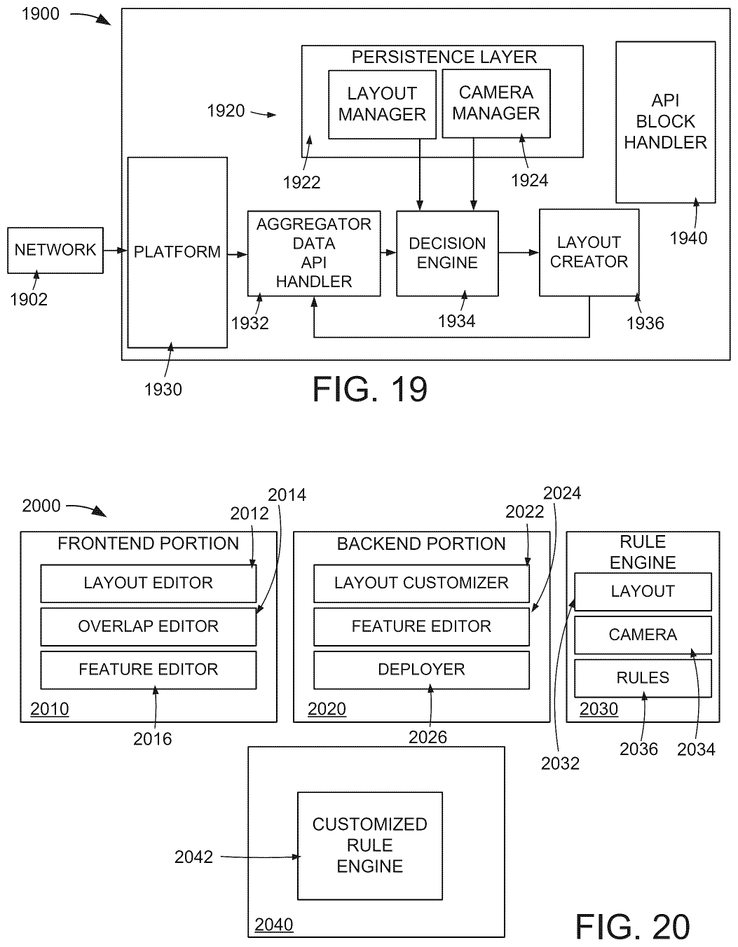

FIG. 19 illustrates an example functional block representation of portions of an example conferencing system 1900 that may be utilized with other aspects of FIGS. 4-18 in accordance with various embodiments. In some embodiments, the system 1900 may connect a rules engine portion 1910 to a network 1902 and provide a persistance layer 1920 where a layout manager 1922 and camera manager 1924 may provide information to the rules engine portion 1910. It is contemplated, but not required, that the managers 1922/1924 may employ parsing and transport aspects to facilitate efficient rules engine 1910 operation.

In some embodiments, information from the network 1902 may initially feed a platform portion 1930 before an aggregator data API handler 1932 transports information to downstream aspects of the rules engine portion 1910. Embodiments of the rules engine portion 1910 provide a primary overlap detector, along with a secondary overlap detector, to feed a decision engine 1934 to generate a composition list that supplies a composition layout creator 1936, which may include an animation sequencer. It is noted, in some embodiments, that the information from the respective managers 1922/1924 of the persistence layer 1920 may additionally feed the decision engine 1934. Assorted software aspects of the rules engine portion 1910 may provide an API block handler portion 1940 that includes a request handler, response handler, ingress validator, and outgress validator.

FIG. 20 illustrates portions of an example intelligent conferencing system 2000 that may be utilized to alter aspects of a virtual environment 104. In the non-limiting example of FIG. 20, there is no need to expose the entire rule engine code to an end customer. Rather, an editor may be provided that empowers customization of specific blocks requiring modification, while the remaining blocks may be deployed with default settings. Furthermore, aspects of the system 2000 may be made available as a cloud-based application that grants an integrator, or end user, the ability to customize the rule engine and deploy it to their preferred location or in a core portion directly.

As such, adopting a rule engine architecture that can provide a customizable solution is more efficient. The level of customization may be selectable, such as whether aspects are fully customizable or allow for partial block-level customization. The non-limiting example shown in FIG. 20 conveys how a frontend portion 2010 may have a layout editor 2012, an overlap editor 2014, and a feature editor 2016 while a backend portion 2020 has a layout customizer 2022, feature editor 2024, and deployer 2026. In some embodiments, a customized rule engine 2030 may be configured with a layout manager 2032, a camera manager 2034, and a rules handler 2036. In some embodiments, a rule engine builder portion 2040 may provide a customized rule engine 2042 that may be deployed and maintained by the outermost layer.

Through the use of the system 2000, all types of customized options, such as simple parameter changes or predetermined drag-and-drop feature sets, along with the efficient editing of code and debugging activity may be provided. The rule engine builder portion 2040 may be deployed and maintained by the outermost layer, which may be characterized as a rule engine builder tool, and supplies all types of customization options, such as operational parameter changes, feature sets, code editing, and debugging capabilities.

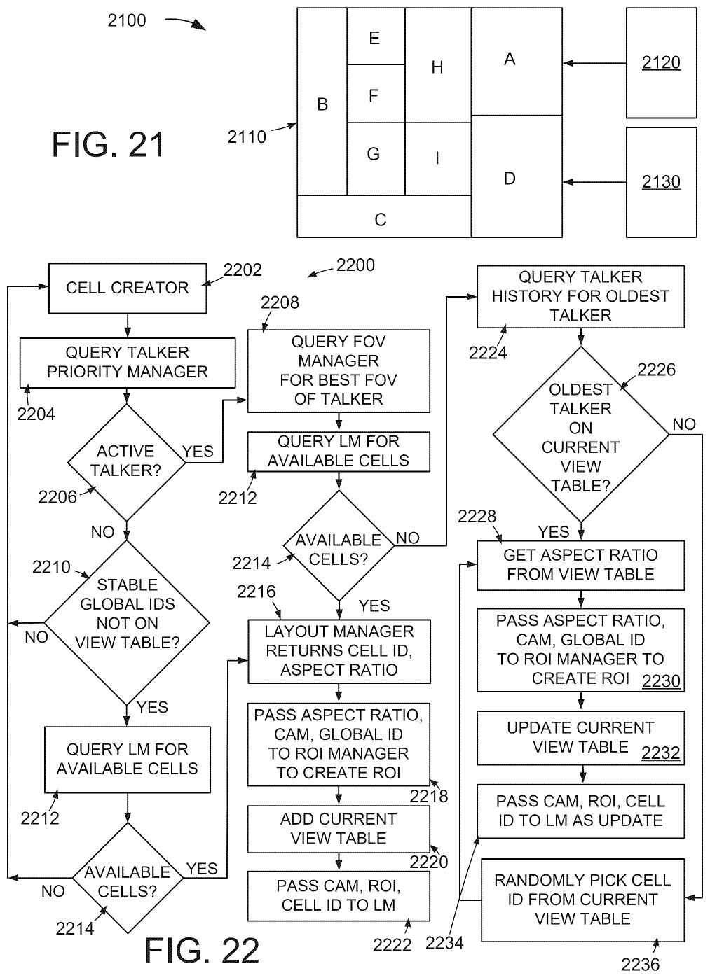

In FIG. 21, a layout portion 2100 shows a potential digital layout 2110 for meeting content. The non-limiting example of the digital layout 2110 conveys how a conferencing system may intelligently organize different digital content, as labeled A-I. That is, digital content may be sized and positioned by a conferencing system to provide a diverse array of layouts that may enhance a meeting experience for a user. The layout portion 2100, in some embodiments, may provide a debug portion 2120 that allows code to be analyzed and an editor portion 2130 that allow for changes, additions, and removal of text that influences the operation of an intelligent conferencing system.

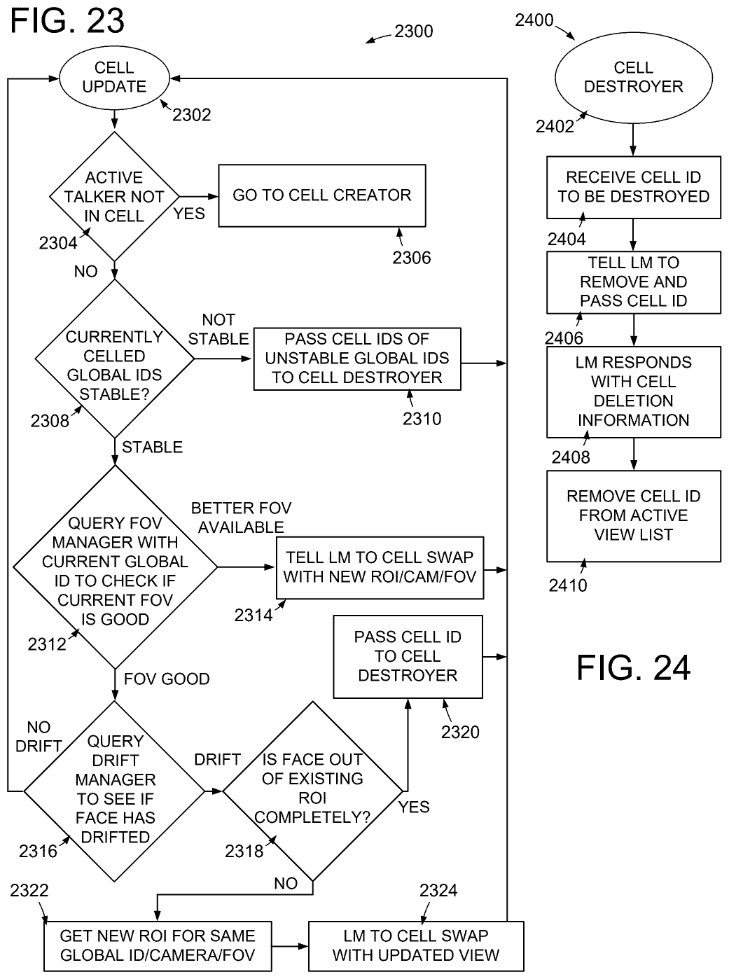

FIGS. 22-24 respectively convey flowcharts of example methods and processes that may be carried out by various embodiments of an intelligent conferencing system. As shown, the steps and decisions 2200 of FIG. 22 may create a cell while the steps and decisions 2300 of FIG. 23 may update a cell. A cell may be destroyed by executing the steps 2400 shown in FIG. 24.

As a result of the assorted embodiments of an intelligent conferencing system, a manual mode may provide traditional camera content feed and control via one or more cameras, which may be switched, panned, tilted, and zoomed when such capabilities are supported. Some embodiments allow a default camera to zoom in on people detected within an active camera's field of view. An auto-framing embodiment of the intelligent conferencing system may focus on a group of people detected within a camera's field of view. Other focusing embodiments provide cropping of multiple individuals and subsequent combination of those participants into a single frame.

A camera, in various embodiments, may utilize multiple camera streams to provide a gallery view that may highlight an active speaker and/or switch between different meeting room views, such as a full room view and an autoframed view. Just as camera switching is available in response to an active participant, microphone switching may track active speakers and activate one or more microphones to optimally gather audio. Assorted embodiments of an intelligent conferencing system may utilize multiple microphones, and/or speakers, to provide separate galleries of a meeting room, or defined space, concurrently.

It is noted that the post-pandemic virtual collaboration market has been hyper-focused on creating meeting equity for the new normal of hybrid work. Customers are interested in enabling these solutions in both new builds for specific hybrid room layouts, but equally as interested in supporting traditional room layouts that don't require significant renovation to meet their user experience goals.

Without enhanced video features, a virtual conferencing system is at risk of losing camera sales as organizations embrace the need for more hybrid equity feature sets. This market interest has been seen with the popularity of software plugins, however, such solutions lacks enough ‘intelligent’ capabilities to truly deliver the end user experience desired by customers. In addition to the market interest driven by existing virtual meeting capabilities that allow hybrid equity focused features sets, embodiments of the intelligent conferencing system collaboration solutions remain popular in the market due to our position as an agnostic solution, with a larger percentage of systems deployed as bring your own device (BYOD) based solutions, or combined BYOD plus conferencing room systems.

Accordingly, the intelligent conferencing system may provide an ability to provide a similar set of features regardless of the primary room experience, such as BYOD or other existing virtual meeting platforms. An intelligent conferencing system may include multi-camera capabilities for high value spaces as well as providing retrofit capabilities where traditional rooms with participants are positioned around conventional furniture, such as a conference table or tapered wing table. Multi-camera configurations may be utilized in training rooms and/or divisible rooms where cameras are placed at common, or dissimilar, locations, such as walls, corners, on tables, or suspended from the ceiling. As such, the intelligent conferencing system may support existing meeting spaces as well as rooms designed with hybrid equity in mind, such as telepresence room layouts that are wide and shallow.

An administrator of the intelligent conferencing system may perform basic design and run time configurations of intelligent camera feature sets. An integrator may perform design time configurations of intelligent camera feature sets while an end user may participate in a meeting with limited technical knowledge of the intelligent conferencing system. A system designer may interface multiple camera and dynamic beamforming microphones with video analytics processing to the target soft-codec with a variety of modes. One such mode is a single stream camera device via universal serial bus interface, which may present a composite feed or grid mode of the various camera streams. Such mode may be compatible with BYOD setups where participant's devices operate in conjunction with existing room equipment.

Another example mode may provide intelligent camera usage that, at least, shows all participants in a meeting room at the beginning of a meeting. Such mode may continue to track the active speaker(s) without operating any controls. The mode may show the far end of a group of participants, or zones, when more than one person is talking. When an active participant moves within a zone, the system may reframe the participants. In response to an active participant moving outside a defined zone, the system may revert to a full frame room view. Operation of a mode may provide both an active talker camera feed as well as a room view feed as separate streams, which allows a picture-in-picture with the full room view within the active talker camera view.

For some software platforms, the nomenclature of various aspects of an intelligent conferencing system may differ from other software platforms. As a non-limiting example, an intelligent conferencing system may be classified as a less than 180° front of the room (FOR) solution, also known as a room view camera. Each video stream may be characterized as a camera and a camera may contain multiple physical and logical camera instances. An active speaker camera may be a video stream view of the active speaker in the room.

An edge intelliframe camera may be synonymous with a multi-cell composite image, which is a single image containing multiple people cells composited together. A multi-stream intelliframe camera may correspond with multi-streaming cells. A face stream may contains just the faces found in the room and may be selectively activated. Such faces may be sent to the cloud where they can cross reference the faces with a database set up by a company that opts-in so it can get real names and associate names with the faces. A room view may provide a stream of the entire field of view for a camera.

FIG. 22 illustrates an embodiment of a method for creating a digital layout cell. In the example of FIG. 22, a digital layout cell, such as the cells labeled A-I in FIG. 21, may be initially created by beginning step 2202, which prompts step 2204 to query a talker priority manager to determine if a talker priority is present. Decision 2206 evaluates if there is an active talker and, if so, step 2208 queries a field of view (FOV) manager to determine the best FOV for the active talker. In the event no meeting participant is actively talking, decision 2210 evaluates if there are stable global IDs that are not on the view table. A layout manager (LM) is queried in step 2212 if there are stable global IDs not on the view table from decision 2210 or after a FOV is provided by the FOV manager in step 2208.

Decision 2214 then determines if any cells are available. Some embodiments return to a beginning step 2202 if no cells are available while other embodiments query a talker history to determine the oldest talker in step 2224 if no cells are available. The availability of cells may trigger step 2216 to allow the layout manager to return a cell ID and an aspect ratio, which is passed, along with a camera, and global ID to a region of interest (ROI) manager to create an ROI in step 2218. The ROI is added to the current view table in step 2220 before the layout manager receives the camera, ROI, and cell ID in step 2222.

Once the oldest talker is determined in step 2224, decision 2226 evaluates if the oldest talker is on the current view table. If so, the view table provides an aspect ratio in step 2228, which is subsequently passed, along with the camera, and global ID to an ROI manager to create an ROI in step 2230. Next, the current view table is updated in step 2232 and the camera, ROI and cell ID are passed to the layout manager as an update in step 2234. Some embodiments may randomly pick a cell ID from the current view table in step 2236 in response to decision 2226 not having the oldest talker on the current view table, which may then proceed to step 2228, as shown.

FIG. 23 illustrates an embodiment of a method for updating a cell of a digital layout. In some embodiments, a cell of a digital layout, such as layout 2110 of FIG. 21, may be updated beginning with initialization step 2302 that allows decision 2304 to evaluate if an active talker is not in a current cell. If so, step 2306 may prompt the cell creation routine (e.g. routine 2200 of FIG. 22) to create a cell. In the event every active talker is in a cell, in some embodiments, decision 2308 evaluates if currently celled global IDs are stable. A determination that one or more cells are not stable may, in some embodiments, prompt step 2310 to pass cell IDs of unstable global IDs to a cell destroyer, such as for example, the cell destroyer routine 2400 of FIG. 24. In some embodiments, stable global IDs celled in a digital layout may trigger decision 2312 to query an FOV manager with current global ID(s) to check if the current FOV(s) are good, which may correspond to correctly sized to accurately present the meeting participant. If a better FOV is available for one or more global IDs, step 2314 may inform the layout manager to swap cells with a new ROI, camera, and/or FOV.

With all global IDs in a good FOV, in some embodiments, decision 2316 may query a drift manager to determine if one or more faces of participants have drifted. In some embodiments, the lack of drift may return to step 2302 while the presence of drift may execute decision 2318 to determine if a face is completely out of an existing ROI. A completely out of ROI face may trigger step 2320 to pass the cell ID to the cell destroyer routine (e.g. routine 2400 of FIG. 24). Meanwhile, a face that is not completely out of an ROI may undergo step 2322 where a new ROI is generated and implemented in step 2324 by prompting the layout manager to swap cells and update the view table.

The destruction of a cell may occur in a variety of manners. One, non-limiting example is shown by routing 2400 of FIG. 24 in which a beginning step 2402 allows one or more cell ID(s) to be received for destruction. Step 2406 then informs the layout manager to remove and pass the cell ID, which is elicits a response in step 2408 from the layout manager with cell deletion information. Finally, the identified cell ID(s) are removed from the active view list in step 2410.

In embodiments, AI engine 1802 and AI aggregator 1820 may provide inference data, including a bounding box of one or more people and a unique global ID for each of the one or more people. However, the AI inference data may include noise that requires suppression. Stabilizer may analyze the inference data to assess how each of the one or more people are reacting within the room. For example, this may include determining behavior, or movements, such as whether a person is idle or moving. To achieve this, the following states may be used to categorize their behavior: stable, moving, idle, and so on. Technical aspects may include using specific threshold parameters, including the following types of bounding boxes: bounding box, moving threshold bounding box, and stabilizing threshold bounding box. In addition, each of the one or more people's movements may be tracked in terms of pixel distance. Once 3D spatial coordinate data relating to the above is available, it will enable tracking of people within the 3D spatial environment. Aggregator 1820 may analyze the 3D spatial coordinate data and create a superset data structure to make informed decisions regarding assigning, removing, replacing, or swapping individuals in the layout, as discussed with reference to at least FIGS. 19-24. The design of the rules engine follows the forward architecture principle, where small pieces of information are incrementally added at each stage.

Layout selector: the conferencing system may provide a pre-defined 14-cell layout when a room view (e.g., a view of a room) is disabled. When the room view is enabled, a user interface may support an 8-cell layout. These 14-cell layouts correspond to configurations such as 1-cell layout, 2-cell layout, and so on, up to the 14-cell layout (e.g., the many cells of FIG. 21). The layout manager 1922 determines the appropriate layout based on the potential individuals who can occupy each layout cell. Layout manager 1922 may consider whether a person can be removed (moved out of the field of view or is already present in the room). Additionally, if there are more people available than the number of cells, the conferencing system may select a layout that accommodates the maximum number of individuals.

Talker Prioritizer: a talker prioritizer may handle prioritizing a talker and ordering the talker to a higher priority than, for example, a non-talker, determining whether a person should be moved to an upper cell, brought to a lower cell, or remain in the same position within the layout.

FOV Selector: In a conferencing system setup, multiple cameras may be employed to achieve the best video experience. Due to the varying field of view (FOV) of these cameras, the same person can be captured from different angles. These angles are simplified as (i) 0 degrees, (ii) Left 45 degrees or Right 45 degrees, or (iii) Left 90 degrees or Right 90 degrees. Using this information, the system selects the best FOV from different stream perspectives during each interaction with the rule engine. If the initially selected best FOV is not suitable for the chosen cell, the system will seek the next best FOV.

ROI Calculator: In the context of a best FOV and a chosen cell within the layout, the bounding box provided by the AI engine may be a face box (e.g., rather than a bounding box capturing an entire or partial body). Unfortunately, this face box alone may not align well with a chosen cell or provide an optimal video experience. To address this, the ROI calculator steps in. The ROI calculator can process conferencing data, including the rectangle coordinates, and creates a region of interest (ROI) based on the bounding box. The ROI calculator can maintain the same aspect ratio as the destination cell (the chosen cell within a layout) while also enlarging the ROI to display a person with shoulder details, similar to a passport-sized photo.

ROI Overlap Detector: when creating the region of interest (ROI), there are cases where multiple people may appear within the same cell. This can lead to suboptimal video experiences, such as only half of a person's shoulder being visible or the same person appearing in multiple cells. To address this, there are two approaches. The first may include individual optimization: if two or more persons are visible within a single ROI, the conferencing system may attempt to find an alternative best field of view (FOV) that accommodates all individuals in a single cell. An aim of this may be to fit one person per cell. If this condition cannot be met, the system proceeds to the next approach. The second approach may be termed a supercell creation: if two or more persons are still visible in a single ROI, they are combined into a single supercell. In this case, the same person will not be considered in another call. This approach may be limited to combining a maximum of two people within the supercell.

Drift Detection: in the physical world, people often move even while sitting—changing positions, rotating, or shifting left and right. However, in our system, a person's position is locked to their designated cell. Over time, this fixed position can become misaligned with the center of the cell. To address this, the conferencing system continuously monitors the person's position. If the conferencing system detects misalignment from the center of the cell (e.g., by measuring movement per pixel relative to a center of a cell or bounding box), the conferencing system can trigger the creation of a new region of interest (ROI). This ensures that the person remains optimally positioned within the layout.

Layout Manager: a layout manager (e.g., layout manager 1922) can retrieve layouts from memory and parse layout information. In a conferencing system setup, the system may allow loading of customer-specific layout designs based on the customer's requirements. By default, a conferencing system may support 14-cell layouts when the room view is disabled, and 8-cell layouts when the room view is enabled. When working with a design page, customers may have two options for providing the layout to the conferencing system: the conferencing system may provide a predefined layout; customers can customize the layout and upload it over the internet using a web page. Additionally, the conferencing system may provide within a user interface various layouts for selection.

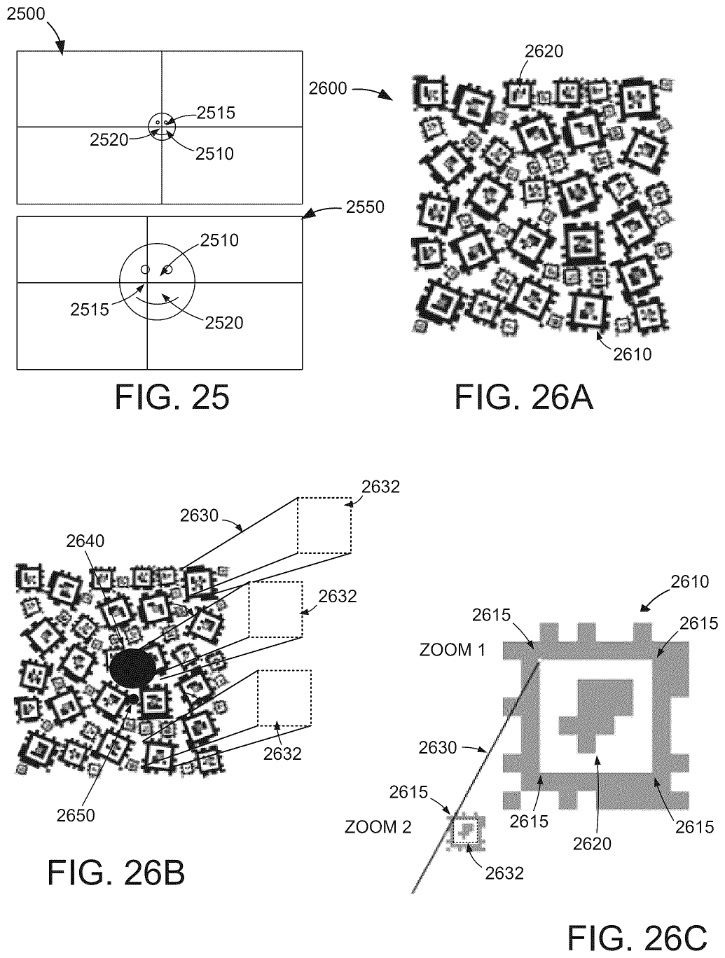

FIGS. 25-30 respectively convey assorted aspects of operating a conferencing system that may provide accurate focal center determination for a camera in accordance with various embodiments. The ability to efficiently identify the focal center of a camera lens in a zoom agnostic manner may allow for the optimization of camera operation, such as recording video, identifying meeting participants, and tracking moving objects within a space.

FIG. 25 generally conveys an example operation of a conferencing system where the focal center of a camera, such as camera 510, may not coincide with an image center. A camera, in some embodiments, may provide camera view 2500 with an object center 2510 and camera center 2515 that are aligned with the focal center 2520 of a camera lens, as illustrated by the vertical and horizontal reference crosshairs in FIG. 25. However, a misalignment of the object image center 2510 with the focal center 2520 and/or camera center 2515 of the camera lens may induce errors in clarity to the point of jeopardizing the accuracy of tracking, identifying, and recording activity of one or more meeting participants.

In the non-limiting instance of camera operation shown by camera view 2550 of FIG. 25, the camera center 2515 is offset and misaligned from the object center 2510. Such misalignment between the object center 2510 and camera center 2515 may additionally coincide with a misalignment with the focal center 2520 of the camera. Although, it is contemplated that the object center 2510 may be aligned with either the camera center 2515 or focal center 2520 while being misaligned with the other of the camera center 2515 or focal center 2520. Hence, a camera utilized in a conferencing system may have a variety of different misalignments that, individually and collectively, create ambiguation, video errors, and object tracking difficulties, particularly when a camera utilizes pan, tilt, and zoom capabilities to record a participant and/or aspects of a meeting space.

It is noted that the focal center/image center misalignment may originate from a physical tolerance resulting from mounting a lens on a semiconductor, such as a system on chip (SOC), integrated circuit, or other substrate. A lens and camera may be fused and the camera board may then be mounted on the moving chassis inside the camera body, which is capable of pan, tilt, and zoom, behind the zoom lensing. Zoom emanates from the zoom focal center on the zoom lens. As the camera moves along its travel track, the image will get bigger and smaller around that focal point. As an example, imagine it is the infinite vanishing point from which all new details in the image come into focus.

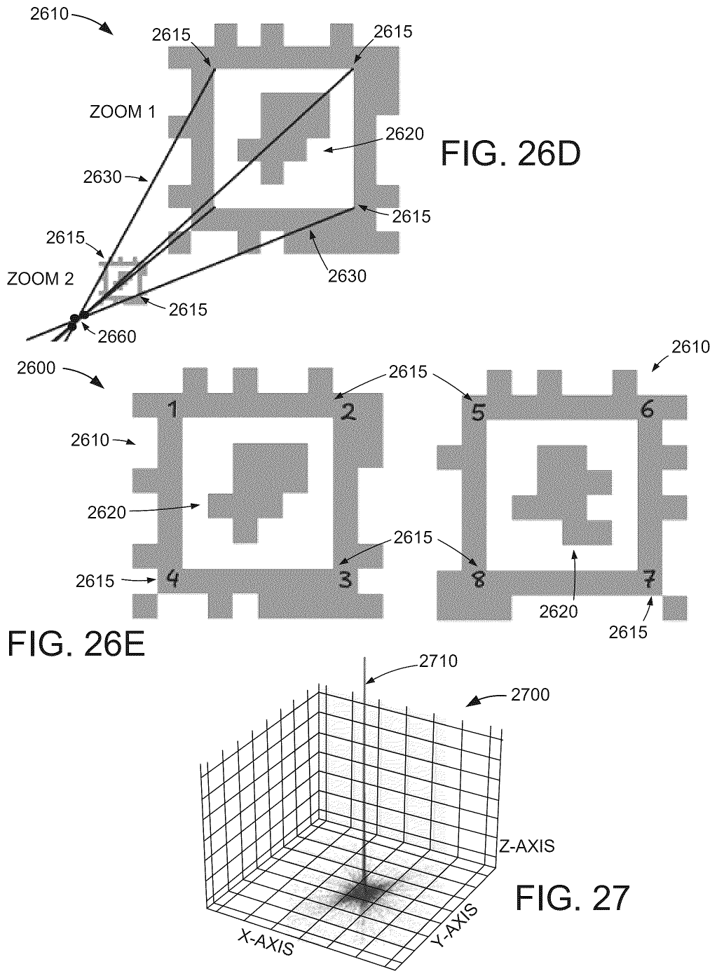

With the focal center/image center misalignment in mind, various embodiments are directed to calibrating for the structural capabilities of a camera lens. That is, embodiments may employ one or more calibration codes 2600, as shown in FIGS. 26A and 26B, to identify misalignment of camera center 2515 and or focal center 2520, which allows the conferencing system to compensate to provide and maintain accurate recording and tracking of meeting participants over a variety of PTZ. A calibration code 2600, as shown in FIG. 26A, may have a number of differently oriented calibration features 2610 that each comprise orientation features 2620 that allow the focal center of a camera lens to be accurately determined in the correct physical orientation while being zoom agnostic. It is noted that the assorted calibration features 2610, and constituent orientation features 2620, may have matching, or dissimilar, visual configurations to allow confluence of calibration rays 2630 during a calibration operation to identify at least the focal center 2640 of a camera.

During a calibration operation conducted by a computing device 102 with the calibration code 2600, the position of the assorted calibration features 2610 may be logged for a variety of different zoom positions for a camera. The resulting position of the calibration features 2610 in various zoom levels, as illustrated as segmented boxes 2632 in FIG. 26B, may be joined by rays 2630 that project onto the calibration code 2600 to inform where the focal center of the camera resides. Through analysis of the rays 2630 formed by the location of the calibration features 2610 at different zoom levels, ray intersections may be identified and logged. A confluence of rays 2630, and ray intersections on the calibration code 2600 may accurately approximate the focal center 2640 of the camera being utilized for the calibration. FIG. 27 conveys an example plot 2700 of rays 2630 that form a centroid 2710 indicating how a few pixels have the majority of the collisions on them to indicate a focal center 2640. Accordingly, the centroid 2710 of those points may be utilized to find the exact position of the camera's focal position.

With the image center 2650 identified on the calibration code 2600, the focal center 2640 of the camera lens may be compared to produce a zoom agnostic video that maintains maximum camera performance, such as participant tracking and activity recording, regardless of the zoom level of the camera. The comparison of the image center 2650 and focal center 2640 may allow a conferencing system to conduct pan and tilt operations while maintaining correct context, depth, and resolution. In contrast, a traditional QR code that utilizes relatively uniform pixelation, such as 5×5 pixel patterns, may not provide a confluence of rays 2630 extending from the bounds of the respective regions of the code for different zoom levels, which would make camera lens image center determination less accurate.

Object misalignment may be observed by drawing a dot 2650 in center of the image before moving one or more of the PTZ capabilities of the camera to align the dot with a specific object. By zooming in/out, the drift and misalignment may be observed. The misalignment/drift may be quantified by comparison to the field of view of the image by observing the field of view drift around the edges while the center is relatively stable. Taking out the field of view and figuring out the field of view degrees per pixel, the pixels can be counted and how it drifts between frames.

FIGS. 26C-26E respectively illustrate calibration features 2610 portions of an example calibration code 2600. In FIG. 26C, the orientation feature 2620 is configured with a visual arrangement that aids in locating a specific aspect of the calibration feature 2610, such as the top-left corner. That is, the orientation feature 2620, as part of a calibration code 2600 with other, unique calibration features, as shown in FIGS. 26A and 26B, may ensure the calibration code 2600 is utilized in a predetermined orientation and rays 2630 are properly aligned with designated corners 2615 of the calibration feature 2610. It is noted that the exterior bounds of the calibration feature 2610 may also provide orientation information, along with the orientation feature 2620, to provide efficient and accurate plotting of rays 2630 and identification of ray collisions that coincide with the focal center 2640 of a camera lens.

By plotting a ray 2630 through the same corner 2615 of a calibration feature 2610 across multiple different zoom levels, such as the zoomed-in (zoom 1) and zoomed-out (zoom 2) levels shown in FIGS. 26C and 26D, ray collisions 2660 may be efficiently identified. Specifically in FIG. 26D, the plotting of rays 2630 to each calibration feature corner 2615 may provide multiple collisions 2660, which may be characterized as ray intersections, that may be counted and analyzed by a conferencing system to get an average position where a calibration code 2600 zooming from, which indicates a focal center 2640. That is, identifying collisions 2660 for numerous separate calibration features 2610 of a calibration code 2600, which are respectively provided by intersecting rays 2630 connecting corners 2615 of a single calibration feature 2610, may be aggregated by the conferencing system to accurately determine the focal center 2640.

FIG. 26E illustrates portions of an example calibration code 2600 arranged in accordance with various embodiments to provide unique calibration features 2610 that collectively indicate the focal center 2640 of a camera lens. It is noted that the corners 2615 of the respective calibration features 2610 are numbered to convey the unique placement of rays 2630 throughout a range of zoom levels, which allows a conferencing system to track how the calibration code 2600 has scaled. Some embodiments of a calibration code 2600 configure the orientation features 2620 to have a winding that clock-wise starting with the top left corner, which may aid in plotting rays 2630 in a calibration operation.

Although not limited, the pixel position of the focal center 2640 may be fixed along its entire travel. By figuring out what pixel offset means in degrees, the impact can be negated by reversing the offset on the current frame and then apply the destination offset. In one example, the current pan/tilt reading is altered to reflect where the center ray is actually pointing. In another example, the camera is moved so the center ray is always aligned at the particular pan/tilt reading. As a result, the camera will seem like its moving without being prompted. The center ray is assumed to be the current pan-tilt location will seem to shift. The shift will be different for each camera and cannot be rectified without a focal center profile.

For non-uniform pixel drift, the source may be radial distortion due to lens non-uniformity, which may be observed visually when the distortion is clear enough to be observed towards the edges of frame. To validate such visual observation, a checkerboard-based camera calibration may be performed as well. The pixel drift may be quantified by sweeping a target in the entire field of view and logging pixel displacement per unit pan/tilt movement. It is contemplated that pixel drift may be rectified by performing one-time factory calibration across all zoom ranges and generate distortion coefficients to undistort the frame. However, auto-focus may present a challenge. As such, one solution may involve collecting the distorted behavior over latitudinal and longitudinal curvatures and homebrew a lens model with distortion embedded in it. Yet, building a fine-resolution non-lateral curvatures for entire field of view may pose a challenge, along with combining those curvatures into a multi-dimensional polynomial surface function, use that function for estimating pixel displacement values.

Some embodiments of a conferencing system employ a computing device to find a focal center 2640. It is contemplated that a lens and camera are fused by a third party supplier followed by mounting of the camera board on the moving chassis inside the PTZ camera body behind the zoom lensing. Camera zoom function may emanate from the zoom focal center 2640 on the zoom lens. As the camera moves along its travel track, an image will get bigger and smaller around that focal point. For instance, a focal point may be characterized as the infinite vanishing point from which all new details in the image come into focus.

Although not exhaustive, there are multiple sources that can cause the misalignment of a focal center 2640, but the root cause is that the focal point on the camera board lensing is not aligned with the focal point in the zoom lensing. Such misalignment may be observed by drawing a dot in center of the image prior to moving the camera's PTZ motors to align the dot with a specific object. By zooming in and out from the specific object, focal drift may be observed.

Focal drift may be quantified through the field-of-view (FOV) of an image. An observed FOV will drift around the edges, as illustrated in FIGS. 26-28, but the center of the image is relatively stable. Embodiments may take the FOV and compute the FOV degrees per pixel, which allows for the counting of pixels and observation of drift between frames. Focal drift may be rectified, in accordance with some embodiments, by fixing the pixel position of the focal center along its entire travel. A computation of the pixel offset, in degrees, allows for the compensation of the impact of the pixel offset by reversing the offset on the current frame and then applying a destination offset.

An example solution to focal drift, as generally shown in FIG. 25, may alter the current pan/tilt reading of a camera to reflect where the center ray is actually pointing. Another example solution may move a camera so the center ray is always aligned at the particular pan/tilt reading. As a result, the camera will seem like its moving without being prompted. The center ray associated with the current pan-tilt location will seem to shift and the shift will be different for each camera and cannot be rectified without a focal center profile.

In some embodiments, a profiler of an intelligent conferencing system may take a series of images at a grid of the calibration code 2600 to identify where the center of magnification is in a comparison of all the images. That center will be the focal center 2640. A series of stepped zoom images taken from a camera at the calibration code 2600 may be input data to output a pixel position where the focal center of the camera is. In operation, a series of pictures zoom are taken to find the codes in the overlapping images and connect the corners with ray lines that go through the center of the image. Next, the collision algorithm is performed to find where all the pairs of lines collide, which indicate the collision point and a pixel position.

A middle dot 2650 of code 2600 is the image center is the being the same codes from a zoomed-in point of view overlayed onto the zoomed out image. Portions of the image may be zoomed out image codes. Any number of lines may connect the same corners between images. Some embodiments install dots to represent the collisions between all the pairs of rays 2630. Analysis between many different levels may be performed to record all the collisions' pixel positions. After counting the pixel positions of each, the pixel position with the most should be the pixel center.

As a non-limiting example of drift calculations that may be conducted by an intelligent conferencing system, once a focal center 2640 is determined, the system may compute the correction factor for the center ray, and the new PTZ value that the center of the image is pointed at in the new zoom value. The focal center, and current PTZ value, may allow the system to output a new PTZ value at a final position. In operation, an intelligent conferencing system may, in some embodiments, alter the current pan/tilt reading to reflect where a center ray is actually pointing. After finding the pixels-per-degree (PPD) values for a zoom value, such as an image size of 1920×1080 with an aspect ratio of 16:9, an FOV on x-axis of 90, an FOV on y-axis of 50.62, a PPD on x-axis of 21.33 at 1× zoom, and PPD on y-axis of 21.33 at 1× zoom, the deviation in degrees may be computed. Accordingly, the system may assume the focal center is +50 pixels on the x-axis and on the y-axis, which results in a deviation of 2.34 degrees on each of the x and y axis.

In some embodiments, drift calculations may move the camera so that the center ray is always aligned at a particular pan/tilt reading. Hence, an intelligent conferencing system may, in some embodiments, move the camera to the focal center by subtracting the current deviation value, zooming, and then adding in the new deviation value by adding a new deviation value, such as the values computed above.

In some embodiments, an intelligent conferencing system may identify distortion in a camera. For instance, due to comparatively large radial distortion on the edges of the frame, picture content at the edges may displace faster than the content around optical center. In order to capture the displacement behavior, in some embodiments, the distortion field may be approximated by the intelligent conferencing system, by building a data-driven pixel displacement surface polynomial function. Such a polynomial function may exhibit the artifacts of non-lateral world movement in the FOV (higher spatial displacement towards edges and less towards corners).

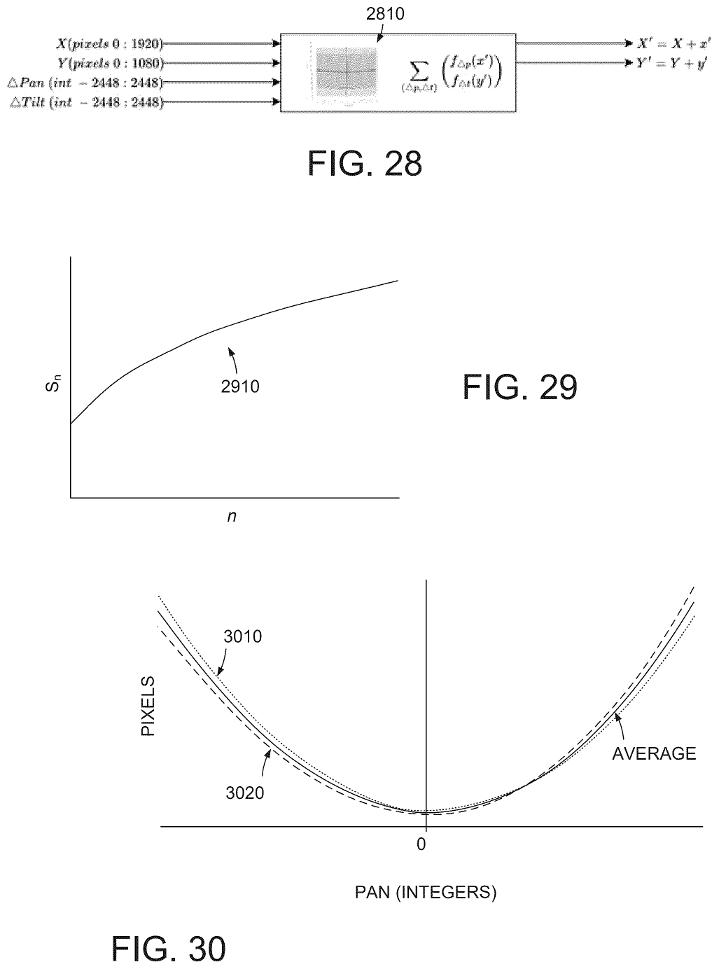

Each polynomial equation, in accordance with some embodiments, may be built on a one-dimensional data vector where a row vector is used for pan and column vector is used for tilt, which illustrates how pixels are situated on a curvature at given pan and tilt values or hfov or vfov values. To collect data to feed the polynomial equation, in some embodiments, a marker may be positioned against the camera, anywhere in the FOV. A log of the marker's position in pixel coordinates, and current pan and tilt values, provides a data instance comprising of a four-element tuple. In some embodiments, the intelligent conferencing system may iteratively collect such instances for required discrete pan/tilt steps. As a result, a function based on surface polynomial of distortion model may return cumulative non-lateral pixel displacement values for any given x-y point in the image plan, as illustrated by the graphical plot 2810 of FIG. 28.

In some embodiments, the intelligent conferencing system may observe a magnitude of error, which may be 66 pixels or more. As zoom proceeds into the higher magnification, the pixel deviation may be a fixed constant, but the FOV may be reduced by the magnification. The system may observe that the drift relates pixels to the FOV and going from 1× to 2× zoom will have the largest deviation. Such deviation, such as 66 pixels, will reduce as the FOV gets smaller. For instance, the intelligent conferencing system may, in some embodiments, calculate a 1920×1080 image with square pixels along with a 90 degree x-axis FOV, which computes to 50.62 degrees on Y-axis. The assumption of 66 pixels as the largest deviation, along with a 21.34 PPD, and initial movement deviation in drift degrees of 3.09 degrees renders that the next jump would be 1.55 degrees, and halved for every step thereafter. FIG. 29 plots a trend line 2910 that conveys how a 4.37 degrees deviation total may be experienced from 1× zoom to 9× zoom, for example.

Various embodiments of an intelligent conferencing system may determine the focal center 2640 for a camera and either: alter the pan/tilt reading to reflect where the center ray is actually pointing; or move the camera so the center ray is always aligned at the particular pan/tilt reading. It is noted that a focal center for separate cameras may be different, sometimes drastically different. Hence, various embodiments of an intelligent conferencing system conduct factory calibration to reduce, or eliminate, differences in focal centers from camera-to-camera. An intelligent conferencing system may observe non-uniform pixel drift.

As a magnitude of error, performance of pixel-drift compensation method was tested by augmenting a point on an aruco tag (ground truth) and then moving pan and tilt to bring the tag to extreme corners, as illustrated in the following chart:

| | | | | | Error′ |
|---|---|---|---|---|---|
| | | | | P′ (x′, y′) | (dx′, dy′) |
| | G. Truth | Point P | Error | [NON- | [NON- |
| | (x, y) | (x, y) | (dx, dy) | LATERAL] | LATERAL] |
| PAN = 0°, | 960, | 960, | 0, 0 | 960, | 0, 0 |
| Tilt = 0° | 538 | 538 | (0°, 0°) | 538 | (0°, 0°) |
| P = −30°, | 1675.25, | 1601.78, | 73.47, 13.75 | 1675.4, | 0.15, 13.75 |
| T = 0° | 525.25 | 539.0 | (1.21°, 0.95°) | 539.0 | (0°, 0.95°) |
| P = 30°, | 258.75, | 318.97, | 60.22, 3.0 | 259.43, | 0.18, 3.0 |
| T = 0° | 543 | 540 | (9.41°, 1.37°) | 540 | (0°, 0.20°) |
| P = −37°, | 1883.25, | 1747.37, | 135.63, 19.75 | 1884.62, | 1.62, 19.75 |
| T = 0° | 519.25 | 539.0 | (9.41°, 1.37°) | 539.0 | (0.11°, 1.37°) |
| (extreme | | | | | |
| right) | | | | | |
| P = −37°, | 1736.25, | 1601.78, | 134.97, 13.16 | 1675.4, | 61.35, 31.39 |
| T = 25.27° | 1047.5 | 1034.34 | (9.37°, 0.91°) | 1078.89 | (4.26°, 2.17°) |
| (extreme | | | | | |
| bottom right | | | | | |
| corner) | | | | | |
| P = 34.86°, | 49.0, | 214.97, | 165.97, 31.21 | 121.02, | 72.02, 11.73 |
| T = −24.30° | 32.5 | 63.71 | (11.52°, 2.16°) | 20.77 | (8.40°, 0.81°) |
| (extreme top | | | | | |
| left corner) | | | | | |

| | | |
|---|---|---|
| MAX ERROR | X: 165.97 (11.52°), | X: 72.02 (8.40°), |
| | Y: 31.21 (2.16°) | Y: 31.39 (2.17°) |

| | |
|---|---|
| ACCURACY P′ over P | 3.12 degrees or ~45 pixel more accurate |
| Absolute Error Margin | 18.6% of the FOV exhibits error, which is |
| | mostly on the edges (9.3% on each side), |
| | The augmentation remains accurate |
| | over 81.4% of FOV |

The pixel drift behavior may be repeatable at least in two cameras, as shown by cameras 3010 and 3020 of FIG. 30. This solution may be scaled to most of the NC12×80s with no or minimal modifications required.

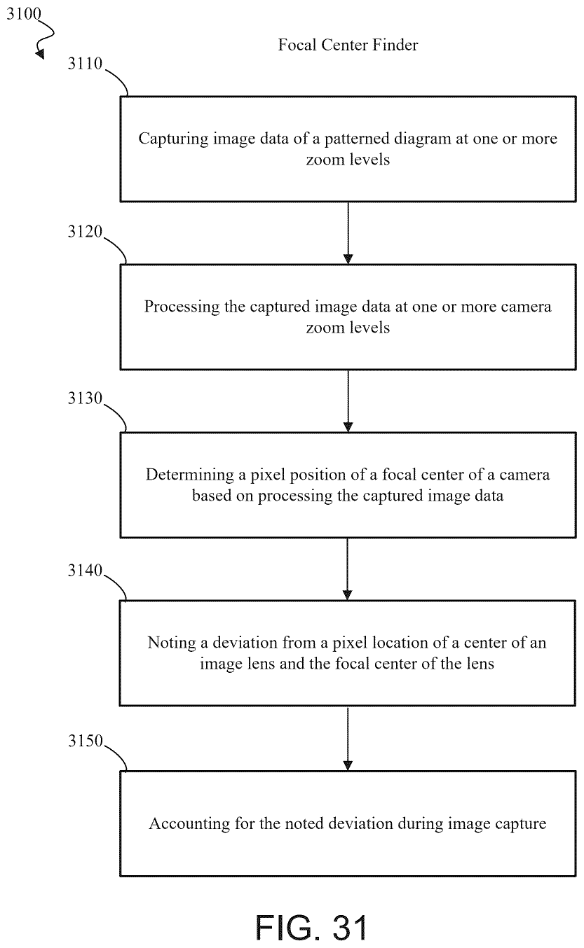

FIG. 31 conveys an example focal center finder method 3100 that may be carried out by a conferencing system in accordance with various embodiments and technical aspects of this disclosure. In some embodiments, method 3100 may include capturing (3110) image data of a patterned diagram (e.g., diagram 2600 with reference to FIGS. 26A and 26B) at various zoom levels. Method 3100, in some embodiments, may include processing (3120) the captured image data. In one example of block AB, rays 2630 relating to the patterned diagram at the various zoom levels are generated and ray density distribution throughout pixels are mapped. In some embodiments, method 3100 may include determining (3120) a pixel position of a focal center of a camera lens based on processing the captured image data. In one example of block 3130, the pixel position is determined based on a certain number of rays (e.g., a pixel that includes the largest number of rays relative to other rays) within the determined pixel.

In some embodiments, method 3100 may include noting (3140) a deviation from a pixel location of a center of an image and the focal center of the camera lens. In one example, the deviation from a pixel location of a center 2650 of an image is noted relative to the pixel location of the center of the camera lens 2515. In some embodiments, method 3100 may include accounting (3150) for the noted deviation during image capture, as discussed above with reference to FIGS. 25 through 30.

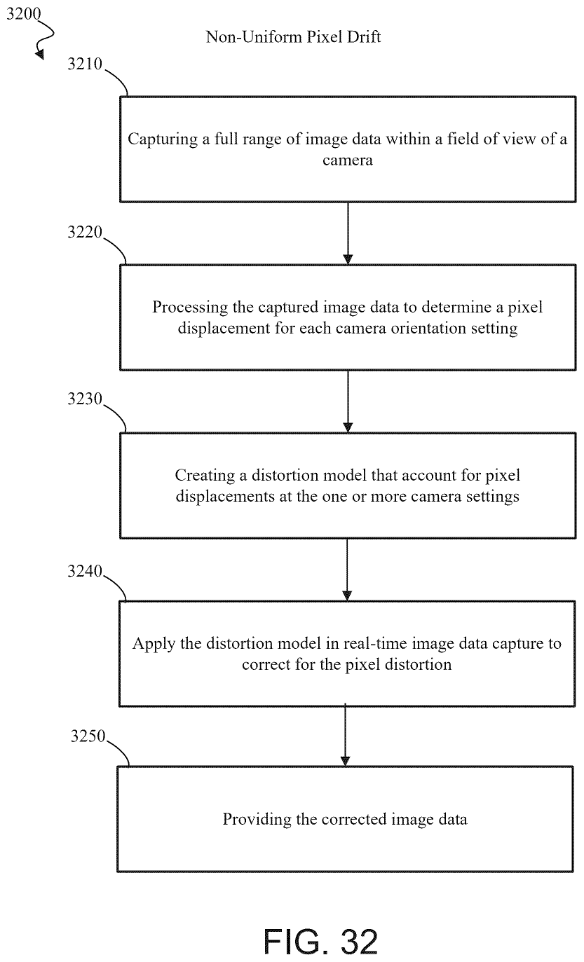

FIG. 32 conveys an example method 3200 that may be carried out by a conferencing system in accordance with various embodiments and technical aspects of this disclosure to identify non-uniform pixel drift. The flowchart of FIG. 32 illustrates how method 3200 may measure and account for non-uniform pixel drift from radial distortion due to lens non-uniformity, according to technical aspects of the present disclosure. In some embodiments, method 3200 may include capturing (3210) a full range of image data within a field of view of a camera. Method 3200 may, in some embodiments, include processing (3220) the image data to determine a pixel displacement for each camera orientation setting. In one example of block 3220, the pixel displacement per unit of each camera orientation setting (e.g., each pan, tilt, zoom setting). In some embodiments, method 3200 may include creating (3230) a distortion model that accounts for pixel displacements at the one or more camera settings. In one example of block 3230, a distortion model is created that accounts for pixel displacement throughout the range of possible camera orientations such that the focal center may align with, for example, an object while changing camera orientations. In one example of block 3230, the distorted behavior over latitudinal and longitudinal curvatures is observed and the distortion model is created. For example, the longitudinal and latitudinal curvatures are incorporated into a multi-dimensional polynomial surface function, that is used for estimating pixel displacement values.

In some embodiments, method 3200 may include applying (3240) the distortion model during real-time image capture to correct for pixel displacement as the camera is dynamically reoriented, for example, during a conference call. Method 3200, in some embodiments, may include providing (3250) the corrected image data.

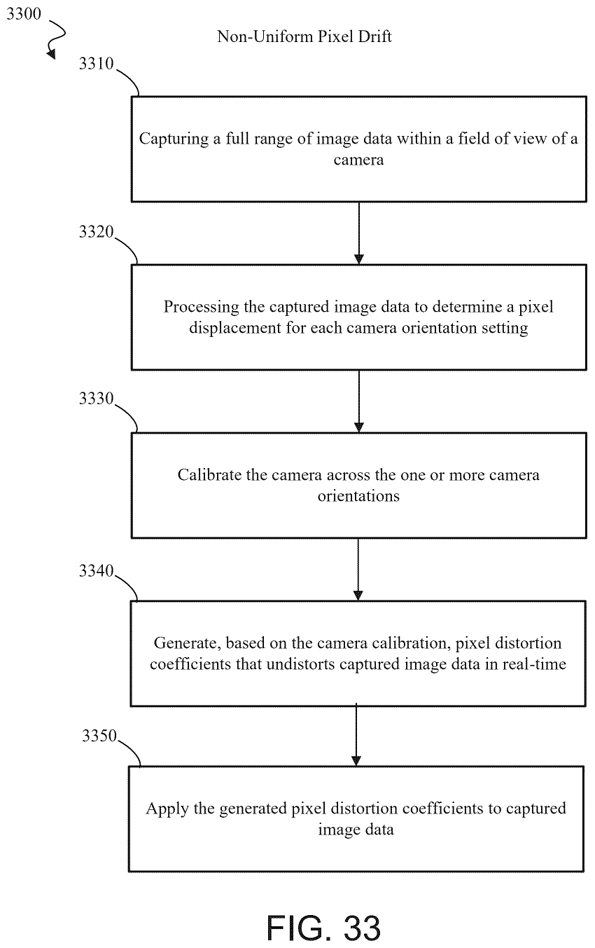

FIG. 33 conveys an example non-uniform pixel drift method 3300 that may be carried out by a conferencing system in accordance with various embodiments and technical aspects of the present disclosure. In some embodiments, method 3300 may measure and account for non-uniform pixel drift from radial distortion due to lens non-uniformity, according to technical aspects of the present disclosure. Method 3300 may, in some embodiments, include capturing (3310) a full range of image data within a field of view of a camera. In some embodiments, method 3300 may include processing (3320) the captured image data to determine a pixel displacement for each camera orientation setting. In some embodiments, method 3300 may include calibrating (3330) the camera across the one or more camera orientations. In some embodiments, method 3300 may include generating (3340) pixel distortion coefficients that undistorts captured image data in real-time. Method 3300, in some embodiments, may include applying (3350) the generated pixel distortion coefficients to captured image data.

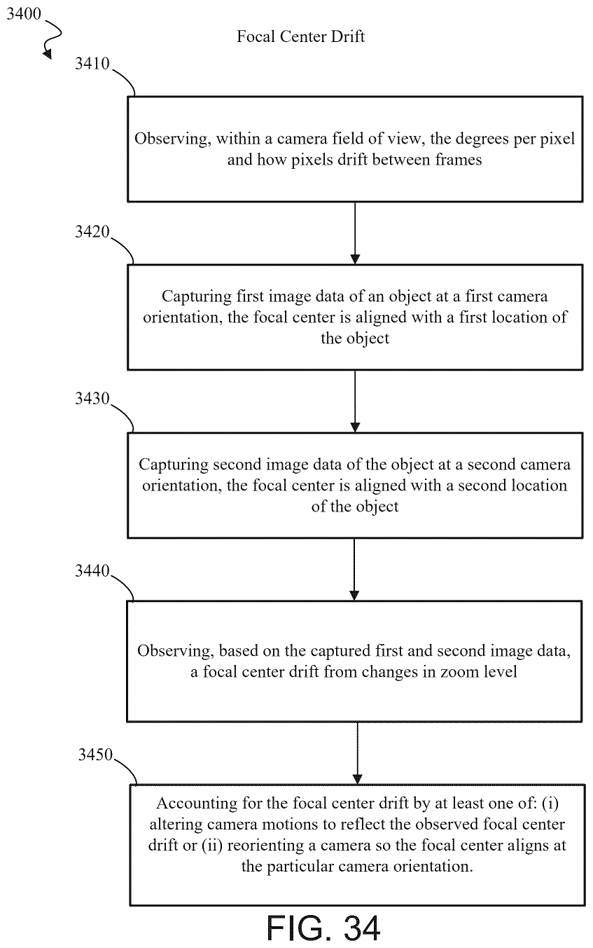

FIG. 34 conveys an example focal center drift method 3400 that may be carried out by a conferencing system in accordance with various embodiments and technical aspects of the present disclosure. In some embodiments, method 3400 may measure focal center drift, according to technical aspects of the present disclosure and may include observing (3410), within a field of view of a camera, the degrees per pixel and how pixels drift between frames. Method 3400 may, in some embodiments, include capturing (3420) image data of an object at a first camera orientation, the focal center is aligned with a first location of the object. In some embodiments, method 3400 may include capturing (3430) a second image of the object at a second camera orientation, the focal center is aligned with a second location of the object. In some embodiments, method 3400 may include observing (3440) a focal center drift relating to the focal center displacement relative to the object from the captured first and second image data. Method 3400, in some embodiments, may include accounting (3450) for the focal center drift by at least one of: (i) dynamically altering camera motions in real-time to reflect the observed focal center drift or (ii) reorienting a camera so the focal center aligns at the particular camera orientation.

Generally, a conferencing system may use one or more distinctive visual features of a meeting room, instead of a known reference microphone or marker, to determine that physical location of cameras and microphones, as well as participants. A conferencing system, in some embodiments, may framing and/or cropping visual features, instead of using body centroid and face ellipse, to track meeting participants.

While some embodiments of a conferencing system utilize a spatializer, which may be characterized as a collision-based approach that is augmented by filtering and grouping of collision points, in combination with global tracking, which may be characterized as matching people based on face descriptors, other embodiments utilize a pipeline, which may be characterized as global Reld, that employs a sensor-fusion-based approach that merges and matches visual and audio data/analytics in “one shot” considering all available “cues”, including spatial video and audio, face and body descriptors/embeddings and voice descriptor. Embodiments of a global Reld may match characteristics across different cameras and also temporally, essentially using the fact that for most people we have a “last known” location as well as “last known” face descriptor, etc.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. A system comprising:
a visual sensor located in a room;
an acoustic sensor located in the room;
a processing unit connected to the visual sensor and the acoustic sensor; and
a calibration module of the processing unit, the calibration module comprising circuitry configured to translate data accumulated from the visual sensor into spatial data that corresponds with a physical location of the acoustic sensor in the room and a field of view operating parameter for the visual sensor.

2. The system of claim 1, wherein the spatial data comprises information describing an object located in the room.

3. The system of claim 1, wherein the processing unit comprises a processor and non-volatile memory.

4. The system of claim 3, wherein the processing unit is physically positioned within the room.

5. The system of any of claims 1, wherein the field of view operating parameter corresponds with an extent of the room observable by the visual sensor.

6. A method comprising:
connecting a processing unit to a first camera and a first microphone in a first meeting room;
generating, with a calibration module of the processing unit, a calibration strategy;
obtaining, with the processing unit, video data from the first camera in accordance with the calibration strategy;
translating, with the processing unit, the video data into spatial data;
identifying, with a mapping module of the processing unit, a physical location of the first microphone in the first meeting room from the spatial data; and
determining, with the calibration module, a field of view operating parameter of the first camera in response to the spatial data.

7. The method of claim 6, further comprising combining, with the processing unit, content from the first camera and the first microphone into a virtual meeting displayed in a second meeting room.

8. The method of claim 6, wherein the calibration strategy prescribes at least one test to obtain the video data pertinent to translating the video information into the spatial data.

9. The method of any of claims 6, wherein the video data is acquired from multiple separate cameras in the first meeting room.

10. The method of any of claims 6, wherein the physical location of the first microphone is unknown by the processing unit until the translating the video data into the spatial data.

11. The method of any of claims 6, wherein the calibration strategy prescribes determining, from the spatial data, physical coordinates of the first microphone within the first meeting room.

12. The method of any of claims 6, further comprising generating an artificial intelligence strategy with the processing unit, the artificial intelligence strategy prescribing at least one test to determine operational capabilities of the first camera.

13. The method of claim 12, further comprising correlating the operational capabilities of the first camera to different physical locations within the first meeting room.

14. A method comprising:
connecting a processing unit to a first camera and a first microphone, each of the first camera and first microphone located in a first meeting room;
connecting the processing unit to a second camera and a second microphone, each of the second camera and second microphone located in a second meeting room;
generating, with a calibration module of the processing unit, a room calibration strategy for the first meeting room and the second meeting room;
conducting the room calibration strategy, with the processing unit, to identify visual characteristics and acoustic characteristics of different locations within each meeting room;
identifying, with a learning module of the processing unit, a first participant in the first meeting room and a second participant in the second meeting room;
assigning, with an identification module of the processing unit, a first unique identifier to the first participant and a second unique identifier to the second participant;
recognizing, with the processing unit, ambiguation in tracking the first participant;
executing, with the processing unit, the room calibration strategy to alter an operating parameter of the first camera to disambiguate tracking of the first participant;
obtaining, with the processing unit, video data from the first camera in accordance with the room calibration strategy;
translating, with the processing unit, the video data into spatial data;
identifying, with a mapping module of the processing unit and from the spatial data, a physical location of the first microphone in the first meeting room and a physical location of the first participant in the first meeting room;
determining, with the calibration module, a field of view operating parameter of the first camera in response to the spatial data; and
adapting, with an adaptation module of the processing unit, at least one operating parameter of the first camera in response to the physical location of the first participant, the adaptation module adapting the at least one operating parameter with respect to the identified physical location of the first participant in the first meeting room.

15. The method of claim 14, further comprising eliminating, with the processing unit, at least one false positive to locate the first participant within the first meeting room.

16. The method of claim 14, further comprising loading, with the processing unit, a participant profile for the first participant in response to identifying the first participant in the first meeting room.

17. The method of claim 16, wherein the operating parameter of the first camera is adapted to provide accurate recording of activity of the first participant in response to the physical location of the first participant within the first meeting room relative to a physical location of the first camera in the first meeting room.

18. The method of any of claims 14, further comprising tracking the first participant over time with the first camera to a plurality of different coordinates within the first meeting room, wherein the plurality of different coordinates are computed by the processing unit.

19. The method of any of claims 14, wherein the room calibration strategy prescribes different operating parameters for the first camera and the first microphone for different physical locations of the first participant in the first meeting room.

20. The method of any of claims 14, further comprising altering an operating parameter of the first camera proactively, with the processing unit, in response to behavior of the first participant predicted by the processing unit.
